(19) United States
(12) Patent Application Publication
(10) Pub. No.: US 2024/0279491 A1
(43) Pub. Date: Aug. 22, 2024

(54) ELECTRODEPOSITABLE COATING COMPOSITIONS

(71) Applicant: PPG Industries Ohio, Inc., Cleveland, OH (US)

(72) Inventors: Corey James DeDomenic, Trafford, PA (US); Reza Michael Rock, Pittsburgh, PA (US); Derek James Saxon, Wexford, PA (US); Christopher Andrew Dacko, Pittsburgh, PA (US)

(73) Assignee: PPG Industries Ohio, Inc., Cleveland, OH (US)

(21) Appl. No.: 18/569,690

(22) PCT Filed: Jun. 24, 2022
(86) PCT No.: PCT/US2022/034967

§ 371 Date: Dec. 13, 2023

Related U.S. Application Data
(60) Provisional application No. 63/202,790, filed on Jun. 24, 2021.

(51) Int. Cl. C09D 5/44; C08K 3/04; C08K 3/34; C09D 7/45; C09D 7/61

(52) U.S. Cl. CPC C09D 5/4457; C09D 5/4453; C09D 5/4465; C09D 7/45; C09D 7/61; C08K 3/04; C08K 3/346; C08K 2201/014

(57) ABSTRACT

The present disclosure is directed to an electrodepositable coating composition comprising an electrodepositable binder comprising an ionic salt group-containing film-forming polymer and a curing agent; and at least one pigment: wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition. Also disclosed are coatings, coated substrates, and methods of coating a substrate.

### FIELD OF THE DISCLOSURE

The present disclosure is directed towards an electrodepositable coating composition, coated substrates, and methods of coating substrates.

### BACKGROUND OF THE DISCLOSURE

Electrodeposition as a coating application method involves deposition of a film-forming composition onto a conductive substrate under the influence of an applied electrical potential. Electrodeposition has become standard in the coatings industry because, by comparison with non-electrophoretic coating means, electrodeposition offers increased paint utilization with less waste, improved corrosion protection to the substrate, and minimal environmental contamination. However, sedimentation in the bath and/or uneven or rough coatings can result for electrodepositable coating compositions having a relatively high amount of pigment. An electrodepositable coating composition having high pigment levels without sedimentation or poor appearance is desired.

### SUMMARY OF THE DISCLOSURE

The present disclosure provides an electrodepositable coating composition comprising an electrodepositable binder comprising an ionic salt group-containing film-forming polymer and a curing agent; and at least one pigment; wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

The present disclosure also provides a method for coating a substrate comprising electrodepositing a coating derived from an electrodepositable coating composition comprising an electrodepositable binder comprising an ionic salt group-containing film-forming polymer and a curing agent; and at least one pigment; wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

The present disclosure further provides a coating formed by depositing a coating from an electrodepositable coating composition comprising an electrodepositable binder comprising an ionic salt group-containing film-forming polymer and a curing agent; and at least one pigment; wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

The present disclosure further provides a substrate that is coated, at least in part, with a coating deposited from an electrodepositable coating composition comprising an electrodepositable binder comprising an ionic salt group-containing film-forming polymer and a curing agent; and at least one pigment; wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

The present disclosure also provides a substrate comprising an electrodeposited coating layer comprising an electrodepositable binder and a pigment, wherein the electrodeposited coating layer has a pigment-to-binder ratio of at least 0.3:1 and the electrodeposited coating layer has a horizontal surface roughness of less than 90 microinches, as measured by the L-PANEL SURFACE ROUGHNESS TEST METHOD.

### DETAILED DESCRIPTION OF THE DISCLOSURE

The present disclosure is directed to an electrodepositable coating composition comprising an electrodepositable binder comprising an ionic salt group-containing film-forming polymer and a curing agent; and at least one pigment; wherein the electrodepositable coating composition has a resin solids content of less than 30% by weight, based on the total weight of the electrodepositable coating composition, and a viscosity of at least 15 cP at a shear rate of 0.1/s, as measured by the BATH VISCOSITY TEST METHOD; and wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

According to the present disclosure, the term “electrodepositable coating composition” refers to a composition that is capable of being deposited onto an electrically conductive substrate under the influence of an applied electrical potential.

As used herein, the term “BATH VISCOSITY TEST METHOD” refers to the test method as described in the Examples section herein.

According to the present disclosure, the electrodepositable coating composition may have a resin solids content of less than 30% by weight, based on the total weight of the electrodepositable coating composition, and a viscosity of at least 15 cP at a shear rate of 0.1/s as measured by the BATH VISCOSITY TEST METHOD, such as at least 25 cP, such as at least 35 cP, such as at least 45 cP, such as at least 55 cP, such as at least 65 cP, such as at least 75 cP, such as at least 85 cP, such as at least 95 cP, such as at least 100 cP.

According to the present disclosure, the electrodepositable coating composition has a resin solids content of less than 30% by weight, based on the total solids of the electrodepositable coating composition, and a viscosity of less than 15 cP at a shear rate of 100/s as measured by the BATH VISCOSITY TEST METHOD, such as less than 12 cP, such as less than 10 cP, such as less than 8 cP, such as less than 6 cP.

According to the present disclosure, the electrodepositable coating composition may have pigment-to-binder ratio of at least 0.3:1 and a coating electrodeposited from the electrodepositable coating composition has a minimum complex viscosity during cure of no more than 5,000 to 300,000 cP, as measured by the COMPLEX VISCOSITY TEST METHOD.

As used herein, the “COMPLEX VISCOSITY TEST METHOD” refers to a procedure used to measure the viscosity of a coating film during a cure cycle, and the method includes the steps of (a) setting up an Anton Paar MCR 302 Rheometer with a PPR 25/23 spindle and 0.1 mm gap; (b) applying tetrahydrofuran (THF) to the uncured electrodeposited coating sample and using a metal spatula to scrape uncured electrodeposited coating sample off of a panel and placing the sample on the Peltier plate; (c) measuring viscosity of the sample over time with the sample under constant shear strain (oscillating) at 5% and frequency at 1 Hz held throughout the length of the test, and a cure cycle of 30 minute ambient flash at 40° ° C. followed by a temperature ramp from 40° ° C. to 175° C. over 41 minutes (3.3° C./min).

According to the present disclosure, a coating deposited from the electrodepositable coating composition may have a horizontal surface roughness of less than 90 microinches, as measured by the L-PANEL SURFACE ROUGHNESS TEST METHOD, such as less than 85 microinches, such as less than 80 microinches, such as less than 75 microinches, such as less than 60 microinches, such as less than 50 microinches, such as less than 45 microinches, such as less than 40 microinches, such as less than 35 microinches, such as less than 30 microinches.

As used herein, the term “L-PANEL SURFACE ROUGHNESS TEST METHOD” refers to the test method as described in the Examples section herein.

According to the present disclosure, a coating deposited from the electrodepositable coating composition has a vertical surface roughness of less than 75 microinches, as measured by the L-PANEL SURFACE ROUGHNESS TEST METHOD, such as less than 60 microinches, such as less than 50 microinches, such as less than 40 microinches, such as less than 30 microinches, such as less than 25 microinches, such as less than 20 microinches, such as less than 15 microinches, such as less than 10 microinches.

According to the present disclosure, the electrodepositable coating composition may have a relative sedimentation of no more than 90 mg/P:B, as measured by the RELATIVE SEDIMENTATION TEST METHOD, such as no more than 85 mg/P:B, such as no more than 80 mg/P:B, such as no more than 50 mg/P:B, such as no more than 40 mg/P:B, such as no more than 35 mg/P:B, such as no more than 25 mg/P:B, such as no more than 20 mg/P:B.

As used herein, the term “RELATIVE SEDIMENTATION TEST METHOD” refers to the test method as described in the Examples section herein.

According to the present disclosure, the electrodepositable coating composition may have a VOC of less than 1.5 lb/gallon (179.7 g/L), such as less than 1.3 lb/gallon (155.8 g/L), such as less than 1.1 lb/gallon (131.8 g/L), such as less than 1.0 lb/gallon (119.8 g/L), such as less than 0.8 lb/gallon (95.9 g/L). As used herein, the term “volatile organic content” or “VOC” refers to organic solvents present in the composition that do not chemically react with the components of the electrodepositable binder or curing agent and have a boiling point of less than 250° C. As used herein, the term “boiling point” refers to the boiling point of a substance at standard atmospheric pressure of 101.325 kPa (1.01325 bar or 1 atm), also referred to as the normal boiling point. The volatile organic content includes volatile organic solvents. As used herein, the term “volatile organic solvent” refers to organic compounds having a boiling point of less than 250° C., such as less than 200° C. The VOC may be calculated according to the following formula:

$$V O C ( g / L ) = \frac{total weight of V O C ( g )}{volume of total composition ( L ) - volume of water ( L )}$$

According to the present disclosure, the electrodepositable binder comprises an ionic salt group-containing film-forming polymer.

According to the present disclosure, the ionic salt group-containing film-forming polymer may comprise a cationic salt group containing film-forming polymer. The cationic salt group-containing film-forming polymer may be used in a cationic electrodepositable coating composition. As used herein, the term “cationic salt group-containing film-forming polymer” refers to polymers that include at least partially neutralized cationic groups, such as sulfonium groups and ammonium groups, that impart a positive charge. As used herein, the term “polymer” encompasses, but is not limited to, oligomers and both homopolymers and copolymers. The cationic salt group-containing film-forming polymer may comprise active hydrogen functional groups. As used herein, the term “active hydrogen functional groups” refers to those groups that are reactive with isocyanates as determined by the Zerewitnoff test as is described in the JOURNAL OF THE AMERICAN CHEMICAL SOCIETY, Vol. 49, page 3181 (1927), and include, for example, hydroxyl groups, primary or secondary amine groups, and thiol groups. Cationic salt group-containing film-forming polymers that comprise active hydrogen functional groups may be referred to as active hydrogen-containing, cationic salt group-containing film-forming polymers.

Examples of polymers that are suitable for use as the cationic salt group-containing film-forming polymer in the present disclosure include, but are not limited to, alkyd polymers, acrylics, polyepoxides, polyamides, polyurethanes, polyureas, polyethers, and polyesters, among others.

More specific examples of suitable active hydrogen-containing, cationic salt group containing film-forming polymers include polyepoxide-amine adducts, such as the adduct of a polyglycidyl ethers of a polyphenol, such as Bisphenol A, and primary and/or secondary amines, such as are described in U.S. Pat. No. 4,031,050 at col. 3, line 27 to col. 5, line 50, U.S. Pat. No. 4,452,963 at col. 5, line 58 to col. 6, line 66, and U.S. Pat. No. 6,017,432 at col. 2, line 66 to col. 6, line 26, these portions of which being incorporated herein by reference. A portion of the amine that is reacted with the polyepoxide may be a ketimine of a polyamine, as is described in U.S. Pat. No. 4,104,147 at col. 6, line 23 to col. 7, line 23, the cited portion of which being incorporated herein by reference. Also suitable are ungelled polyepoxide-polyoxyalkylenepolyamine resins, such as are described in U.S. Pat. No. 4,432,850 at col. 2, line 60 to col. 5, line 58, the cited portion of which being incorporated herein by reference. In addition, cationic acrylic resins, such as those described in U.S. Pat. No. 3,455,806 at col. 2, line 18 to col. 3, line 61 and 3,928,157 at col. 2, line 29 to col. 3, line 21, these portions of both of which are incorporated herein by reference, may be used.

Besides amine salt group-containing resins, quaternary ammonium salt group-containing resins may also be employed as a cationic salt group-containing film-forming polymer in the present disclosure. Examples of these resins are those which are formed from reacting an organic polyepoxide with a tertiary amine acid salt. Such resins are described in U.S. Pat. No. 3,962,165 at col. 2, line 3 to col. 11, line 7; 3,975,346 at col. 1, line 62 to col. 17, line 25 and 4,001,156 at col. 1, line 37 to col. 16, line 7, these portions of which being incorporated herein by reference. Examples of other suitable cationic resins include ternary sulfonium salt group-containing resins, such as those described in U.S. Pat. No. 3,793,278 at col. 1, line 32 to col. 5, line 20, this portion of which being incorporated herein by reference. Also, cationic resins which cure via a transesterification mechanism, such as described in European Pat. Application No. 12463B1 at pg. 2, line 1 to pg. 6, line 25, this portion of which being incorporated herein by reference, may also be employed.

Other suitable cationic salt group-containing film-forming polymers include those that may form photodegradation resistant electrodepositable coating compositions. Such polymers include the polymers comprising cationic amine salt groups which are derived from pendant and/or terminal amino groups that are disclosed in U.S. Pat. Application Publication No. 2003/0054193 A1 at paragraphs to [0088], this portion of which being incorporated herein by reference. Also suitable are the active hydrogen-containing, cationic salt group-containing resins derived from a polyglycidyl ether of a polyhydric phenol that is essentially free of aliphatic carbon atoms to which are bonded more than one aromatic group, which are described in U.S. Pat. Application Publication No. 2003/0054193 A1 at paragraphs to [0123], this portion of which being incorporated herein by reference.

The active hydrogen-containing, cationic salt group-containing film-forming polymer is made cationic and water dispersible by at least partial neutralization with a resin neutralizing acid. Suitable resin neutralizing acids include organic and inorganic acids. Non-limiting examples of suitable organic acids include formic acid, acetic acid, methanesulfonic acid, and lactic acid. Non-limiting examples of suitable inorganic acids include phosphoric acid and sulfamic acid. By “sulfamic acid” is meant sulfamic acid itself or derivatives thereof such as those having the formula:

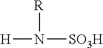

wherein R is hydrogen or an alkyl group having 1 to 4 carbon atoms. Mixtures of the above-mentioned acids also may be used in the present disclosure.

The extent of neutralization of the cationic salt group-containing film-forming polymer may vary with the particular polymer involved. However, sufficient resin neutralizing acid should be used to sufficiently neutralize the cationic salt-group containing film-forming polymer such that the cationic salt-group containing film-forming polymer may be dispersed in an aqueous dispersing medium. For example, the amount of resin neutralizing acid used may provide at least 20% of all of the total theoretical neutralization. Excess acid may also be used beyond the amount required for 100% total theoretical neutralization. For example, the amount of resin neutralizing acid used to neutralize the cationic salt group-containing film-forming polymer may be ≥0.1% based on the total amines in the active hydrogen-containing, cationic salt group-containing film-forming polymer. Alternatively, the amount of resin neutralizing acid used to neutralize the active hydrogen-containing, cationic salt group-containing film-forming polymer may be ≤100% based on the total amines in the active hydrogen-containing, cationic salt group-containing film-forming polymer. The total amount of resin neutralizing acid used to neutralize the cationic salt group-containing film-forming polymer may range between any combination of values, which were recited in the preceding sentences, inclusive of the recited values. For example, the total amount of resin neutralizing acid used to neutralize the active hydrogen-containing, cationic salt group-containing film-forming polymer may be 20%, 35%, 50%, 60%, or 80% based on the total amines in the cationic salt group-containing film-forming polymer.

According to the present disclosure, the cationic salt group-containing film-forming polymer may be present in the cationic electrodepositable coating composition in an amount of at least 40% by weight, such as at least 50% by weight, such as at least 60% by weight, based on the total weight of the resin solids of the electrodepositable coating composition. The cationic salt group-containing film-forming polymer may be present in the cationic electrodepositable coating composition in an amount of no more than 90% by weight, such as no more than 80% by weight, such as no more than 75% by weight, based on the total weight of the resin solids of the electrodepositable coating composition. The cationic salt group-containing film-forming polymer may be present in the cationic electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 60% to 90% by weight, such as 60% to 80% by weight, such as 60% to 75% by weight, based on the total weight of the resin solids of the electrodepositable coating composition.

As used herein, the “resin solids” include the ionic salt group-containing film-forming polymer, the curing agent, and any additional water-dispersible non-pigmented component(s) present in the electrodepositable coating composition.

According to the present disclosure, the ionic salt group containing film-forming polymer may comprise an anionic salt group containing film-forming polymer. As used herein, the term “anionic salt group containing film-forming polymer” refers to an anionic polymer comprising at least partially neutralized anionic functional groups, such as carboxylic acid and phosphoric acid groups that impart a negative charge. As used herein, the term “polymer” encompasses, but is not limited to, oligomers and both homopolymers and copolymers. The anionic salt group-containing film-forming polymer may comprise active hydrogen functional groups. As used herein, the term “active hydrogen functional groups” refers to those groups that are reactive with isocyanates as determined by the Zerewitinoff test as discussed above, and include, for example, hydroxyl groups, primary or secondary amine groups, and thiol groups. Anionic salt group-containing film-forming polymers that comprise active hydrogen functional groups may be referred to as active hydrogen-containing, anionic salt group-containing film-forming polymers. The anionic salt group containing film-forming polymer may be used in an anionic electrodepositable coating composition.

The anionic salt group-containing film-forming polymer may comprise base-solubilized, carboxylic acid group-containing film-forming polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable anionic electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. Other acid functional polymers may also be used such as phosphatized polyepoxide or phosphatized acrylic polymers. Exemplary phosphatized polyepoxides are disclosed in U.S. Pat. Application Publication No. 2009-0045071 at [0004]-[0015] and U.S. patent application Ser. No. 13/232,093 at [0014]-[0040], the cited portions of which being incorporated herein by reference. Also suitable are resins comprising one or more pendent carbamate functional groups, such as those described in U.S. Pat. No. 6,165,338.

According to the present disclosure, the anionic salt group-containing film-forming polymer may be present in the anionic electrodepositable coating composition in an amount of at least 50% by weight, such as at least 55% by weight, such as at least 60% by weight, based on the total weight of the resin solids of the electrodepositable coating composition. The anionic salt group-containing film-forming polymer may be present in the anionic electrodepositable coating composition in an amount of no more than 90% by weight, such as no more than 80% by weight, such as no more than 75% by weight, based on the total weight of the resin solids of the electrodepositable coating composition. The anionic salt group-containing film-forming polymer may be present in the anionic electrodepositable coating composition in an amount 50% to 90%, such as 50% to 80% by weight, such as 50% to 75% by weight, such as 55% to 90% by weight, such as 55% to 80%, such as 55% to 75% by weight, such as 60% to 90% by weight, such as 60% to 80% by weight, such as 60% to 75%, based on the total weight of the resin solids of the electrodepositable coating composition.

According to the present disclosure, the ionic salt group-containing film-forming polymer may be present in the electrodepositable coating composition in an amount of at least 40% by weight, such as at least 50% by weight, such as at least 55% by weight, such as at least 60% by weight, based on the total weight of the resin solids of the electrodepositable coating composition. The ionic salt group-containing film-forming polymer may be present in the electrodepositable coating composition in an amount of no more than 90% by weight, such as no more than 80% by weight, such as no more than 75% by weight, based on the total weight of the resin solids of the electrodepositable coating composition. The ionic salt group-containing film-forming polymer may be present in the electrodepositable coating composition in an amount of 40% to 90% by weight, such as 40% to 80% by weight, such as 40% to 75% by weight, such as 50% to 90% by weight, such as 50% to 80% by weight, such as 50% to 75% by weight, such as 55% to 90% by weight, such as 55% to 80% by weight, such as 55% to 75% by weight, such as 60% to 90% by weight, such as 60% to 80% by weight, such as 60% to 75% by weight, based on the total weight of the resin solids of the electrodepositable coating composition.

According to the present disclosure, the electrodepositable coating composition of the present disclosure further comprises a curing agent. The curing agent may react with the reactive groups, such as active hydrogen groups, of the ionic salt group-containing film-forming polymer to effectuate cure of the coating composition to form a coating. As used herein, the term “cure”, “cured” or similar terms, as used in connection with the electrodepositable coating compositions described herein, means that at least a portion of the components that form the electrodepositable coating composition are crosslinked to form a coating. Additionally, curing of the electrodepositable coating composition refers to subjecting said composition to curing conditions (e.g., elevated temperature) leading to the reaction of the reactive functional groups of the components of the electrodepositable coating composition, and resulting in the crosslinking of the components of the composition and formation of an at least partially cured coating. Non-limiting examples of suitable curing agents are at least partially blocked polyisocyanates, aminoplast resins and phenoplast resins, such as phenolformaldehyde condensates including allyl ether derivatives thereof.

Suitable at least partially blocked polyisocyanates include aliphatic polyisocyanates, aromatic polyisocyanates, and mixtures thereof. The curing agent may comprise an at least partially blocked aliphatic polyisocyanate. Suitable at least partially blocked aliphatic polyisocyanates include, for example, fully blocked aliphatic polyisocyanates, such as those described in U.S. Pat. No. 3,984,299 at col. 1 line 57 to col. 3 line 15, this portion of which is incorporated herein by reference, or partially blocked aliphatic polyisocyanates that are reacted with the polymer backbone, such as is described in U.S. Pat. No. 3,947,338 at col. 2 line 65 to col. 4 line 30, this portion of which is also incorporated herein by reference. By “blocked” is meant that the isocyanate groups have been reacted with a compound such that the resultant blocked isocyanate group is stable to active hydrogens at ambient temperature but reactive with active hydrogens in the film forming polymer at elevated temperatures, such as between 90° C. and 200° ° C. The polyisocyanate curing agent may be a fully blocked polyisocyanate with substantially no free isocyanate groups.

The polyisocyanate curing agent may comprise a diisocyanate, higher functional polyisocyanates or combinations thereof. For example, the polyisocyanate curing agent may comprise aliphatic and/or aromatic polyisocyanates. Aliphatic polyisocyanates may include (i) alkylene isocyanates, such as trimethylene diisocyanate, tetramethylene diisocyanate, pentamethylene diisocyanate, hexamethylene diisocyanate (“HDI”), 1,2-propylene diisocyanate, 1,2-butylene diisocyanate, 2,3-butylene diisocyanate, 1,3-butylene diisocyanate, ethylidene diisocyanate, and butylidene diisocyanate, and (ii) cycloalkylene isocyanates, such as 1,3-cyclopentane diisocyanate, 1,4-cyclohexane diisocyanate, 1,2-cyclohexane diisocyanate, isophorone diisocyanate, methylene bis(4-cyclohexylisocyanate) (“HMDI”), the cyclo-trimer of 1,6-hexmethylene diisocyanate (also known as the isocyanurate trimer of HDI, commercially available as Desmodur N3300 from Convestro AG), and meta-tetramethylxylylene diisocyanate (commercially available as TMXDI® from Allnex SA). Aromatic polyisocyanates may include (i) arylene isocyanates, such as m-phenylene diisocyanate, p-phenylene diisocyanate, 1,5-naphthalene diisocyanate and 1,4-naphthalene diisocyanate, and (ii) alkarylene isocyanates, such as 4,4′-diphenylene methane (“MDI”), 2,4-tolylene or 2,6-tolylene diisocyanate (“TDI”), or mixtures thereof, 4,4-toluidine diisocyanate and xylylene diisocyanate. Triisocyanates, such as triphenyl methane-4,4′,4″-triisocyanate, 1,3,5-triisocyanato benzene and 2,4,6-triisocyanato toluene, tetraisocyanates, such as 4,4′-diphenyldimethyl methane-2,2′,5,5′-tetraisocyanate, and polymerized polyisocyanates, such as tolylene diisocyanate dimers and trimers and the like, may also be used. The curing agent may comprise a blocked polyisocyanate selected from a polymeric polyisocyanate, such as polymeric HDI, polymeric MDI, polymeric isophorone diisocyanate, and the like. The curing agent may also comprise a blocked trimer of hexamethylene diisocyanate available as Desmodur N3300® from Covestro AG. Mixtures of polyisocyanate curing agents may also be used.

The polyisocyanate curing agent may be at least partially blocked with at least one blocking agent selected from a 1,2-alkane diol, for example 1,2-propanediol; a 1,3-alkane diol, for example 1,3-butanediol; a benzylic alcohol, for example, benzyl alcohol; an allylic alcohol, for example, allyl alcohol; caprolactam; a dialkylamine, for example dibutylamine; and mixtures thereof. The polyisocyanate curing agent may be at least partially blocked with at least one 1,2-alkane diol having three or more carbon atoms, for example 1,2-butanediol.

Other suitable blocking agents include aliphatic, cycloaliphatic, or aromatic alkyl monoalcohols or phenolic compounds, including, for example, lower aliphatic alcohols, such as methanol, ethanol, and n-butanol; cycloaliphatic alcohols, such as cyclohexanol; aromatic-alkyl alcohols, such as phenyl carbinol and methylphenyl carbinol; and phenolic compounds, such as phenol itself and substituted phenols wherein the substituents do not affect coating operations, such as cresol and nitrophenol. Glycol ethers and glycol amines may also be used as blocking agents. Suitable glycol ethers include ethylene glycol butyl ether, diethylene glycol butyl ether, ethylene glycol methyl ether and propylene glycol methyl ether. Other suitable blocking agents include oximes, such as methyl ethyl ketoxime, acetone oxime and cyclohexanone oxime.

For example, the blocking agent may comprise an ether or polyether comprising a hydroxyl group and a terminal group having the structure —O—R, wherein R is a C₁ to C₈ alkyl group, such as C₁ to C₄ alkyl group, such as a C₁ to C₃ alkyl group, or two terminal hydroxyl groups. The polyether may comprise a homopolymer, block copolymer, or random copolymer. For example, the polyether may comprise a homopolymer of ethylene oxide or propylene oxide, or the polyether may comprise block or random copolymer comprising a combination of ethylene oxide and propylene oxide in a block or random pattern. Such blocking agent may comprise the structure:

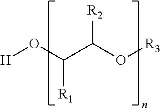

wherein R₁ and R₂ are each hydrogen or one of the R₁ and R₂ is hydrogen and the other is a methyl group; R₃ is H or a C₁ to C₈ alkyl group, such as a C₁ to C₄ alkyl group, such as a C₁ to C₃ alkyl group; and n is an integer from 1-50, such as from 1-40, such as from 1-30, such as from 1-20, such as from 1-12, such as from 1-8, such as from 1-6, such as from 1-4, such as from 2-50, such as from 2-40, such as from 2-30, such as from 2-20, such as from 2-12, such as from 2-8, such as from 2-6, such as from 2-4, such as from 3-50, such as from 3-40, such as from 3-30, such as from 3-20, such as from 3-12, such as from 3-8, such as from 3-6, such as from 3-4.

For example, the blocking agent may comprise an ethoxylated bisphenol. Such blocking agent may comprise the structure:

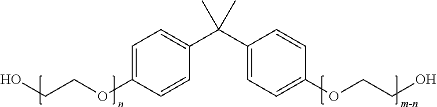

wherein n is an integer and m is an integer from 1 to 20. For example, m and n may be equal and may each independently be 2, 3, 4, 5, 6, 7, 8, 9, or 10. In other examples, m and n are not equal and may be any combination of integers that add up to 20.

The curing agent may optionally comprise a high molecular weight volatile group. As used herein, the term “high molecular weight volatile group” refers to blocking agents and other organic byproducts that are produced and volatilized during the curing reaction of the electrodepositable coating composition having a molecular weight of at least 70 g/mol, such as at least 125 g/mol, such as at least 160 g/mol, such as at least 195 g/mol, such as at least 400 g/mol, such as at least 700 g/mol, such as at least 1000 g/mol, or higher, and may range from 70 to 1,000 g/mol, such as 160 to 1,000 g/mol, such as 195 to 1,000 g/mol, such as 400 to 1,000 g/mol, such as 700 to 1,000 g/mol. For example, the organic byproducts may include alcoholic byproducts resulting from the reaction of the film-forming polymer and an aminoplast or phenoplast curing agent, and the blocking agents may include organic compounds, including alcohols, used to block isocyanato groups of polyisocyanates that are unblocked during cure. For clarity, the high molecular weight volatile groups are covalently bound to the curing agent prior to cure, and explicitly exclude any organic solvents that may be present in the electrodepositable coating composition. Upon curing, the pigment-to-binder ratio of the deposited film may increase in the cured film relative to deposited uncured pigment-to-binder ratio in the electrodepositable coating composition because of the loss of a higher mass of the blocking agents and other organic byproducts derived from the curing agent that are volatilized during cure. High molecular weight volatile groups may comprise 5% to 50% by weight of the film-forming binder, such as 7% to 45% by weight, such as 9% to 40% by weight, such as 11% to 35%, such as 13% to 30%, based on the total weight of the film-forming binder. The high molecular weight volatile groups and other lower molecular weight volatile organic compounds produced during cure, such as lower molecular weight blocking agents and organic byproducts produced during cure, may be present in an amount such that the relative weight loss of the film-forming binder deposited onto the substrate relative to the weight of the film-forming binder after cure is an amount of 5% to 50% by weight of the film-forming binder, such as 7% to 45% by weight, such as 9% to 40% by weight, such as 11% to 35%, such as 13% to 30%, based on the total weight of the film-forming binder before and after cure.

The curing agent may comprise an aminoplast resin. Aminoplast resins are condensation products of an aldehyde with an amino- or amido-group carrying substance. Condensation products obtained from the reaction of alcohols and an aldehyde with melamine, urea or benzoguanamine may be used. However, condensation products of other amines and amides may also be employed, for example, aldehyde condensates of triazines, diazines, triazoles, guanidines, guanamines and alkyl- and aryl-substituted derivatives of such compounds, including alkyl- and aryl-substituted ureas and alkyl- and aryl-substituted melamines. Some examples of such compounds are N,N′-dimethyl urea, benzourea, dicyandiamide, formaguanamine, acetoguanamine, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, 3,4,6-tris(ethylamino)-1,3,5-triazine, and the like. Suitable aldehydes include formaldehyde, acetaldehyde, crotonaldehyde, acrolein, benzaldehyde, furfural, glyoxal and the like.

The aminoplast resins may contain methylol or similar alkylol groups, and at least a portion of these alkylol groups may be etherified by a reaction with an alcohol to provide organic solvent-soluble resins. Any monohydric alcohol may be employed for this purpose, including such alcohols as methanol, ethanol, propanol, butanol, pentanol, hexanol, heptanol and others, as well as benzyl alcohol and other aromatic alcohols, cyclic alcohol such as cyclohexanol, monoethers of glycols such as Cello solves and Carbitols, and halogen-substituted or other substituted alcohols, such as 3-chloropropanol and butoxyethanol.

Non-limiting examples of commercially available aminoplast resins are those available under the trademark CYMEL® from Allnex Belgium SA/NV, such as CYMEL 1130 and 1156, and RESIMENE® from INEOS Melamines, such as RESIMENE 750 and 753. Examples of suitable aminoplast resins also include those described in U.S. Pat. No. 3,937,679 at col. 16, line 3 to col. 17, line 47, this portion of which being hereby incorporated by reference. As is disclosed in the aforementioned portion of the '679 patent, the aminoplast may be used in combination with the methylol phenol ethers.

Phenoplast resins are formed by the condensation of an aldehyde and a phenol. Suitable aldehydes include formaldehyde and acetaldehyde. Methylene-releasing and aldehyde-releasing agents, such as paraformaldehyde and hexamethylene tetramine, may also be utilized as the aldehyde agent. Various phenols may be used, such as phenol itself, a cresol, or a substituted phenol in which a hydrocarbon radical having either a straight chain, a branched chain or a cyclic structure is substituted for a hydrogen in the aromatic ring. Mixtures of phenols may also be employed. Some specific examples of suitable phenols are p-phenylphenol, p-tert-butylphenol, p-tert-amylphenol, cyclopentylphenol and unsaturated hydrocarbon-substituted phenols, such as the monobutenyl phenols containing a butenyl group in ortho, meta or para position, and where the double bond occurs in various positions in the hydrocarbon chain.

Aminoplast and phenoplast resins, as described above, are described in U.S. Pat. No. 4,812,215 at col. 6, line 20 to col. 7, line 12, the cited portion of which being incorporated herein by reference.

The curing agent may be present in the cationic electrodepositable coating composition in an amount of at least 10% by weight, such as at least 20% by weight, such as at least 25% by weight, based on the total weight of the resin solids of the electrodepositable coating composition. The curing agent may be present in the cationic electrodepositable coating composition in an amount of no more than 60% by weight, such as no more than 50% by weight, such as no more than 40% by weight, based on the total weight of the resin solids of the electrodepositable coating composition. The curing agent may be present in the cationic electrodepositable coating composition in an amount of 10% to 60% by weight, such as 10% to 50% by weight, such as 10% to 40% by weight, such as 20% to 60% by weight, such as 20% to 50% by weight, such as 20% to 40% by weight, such as 25% to 60% by weight, such as 25% to 50% by weight, such as 25% to 40% by weight, based on the total weight of the resin solids of the electrodepositable coating composition.

The curing agent may be present in the anionic electrodepositable coating composition in an amount of at least 10% by weight, such as at least 20% by weight, such as at least 25% by weight, based on the total weight of the resin solids of the electrodepositable coating composition. The curing agent may be present in the anionic electrodepositable coating composition in an amount of no more than 50% by weight, such as no more than 45% by weight, such as no more than 40% by weight, based on the total weight of the resin solids of the electrodepositable coating composition. The curing agent may be present in the anionic electrodepositable coating composition in an amount of 10% to 50% by weight, such as 10% to 45% by weight, such as 10% to 40% by weight, such as 20% to 50% by weight, such as 20% to 45% by weight, such as 20% to 40% by weight, such as 25% to 50% by weight, such as 25% to 45% by weight, such as 25% to 40% by weight, based on the total weight of the resin solids of the electrodepositable coating composition.

The curing agent may be present in the electrodepositable coating composition in an amount of at least 10% by weight, such as at least 20% by weight, such as at least 25% by weight, based on the total weight of the resin solids of the electrodepositable coating composition. The curing agent may be present in the electrodepositable coating composition in an amount of no more than 60% by weight, such as no more than 50% by weight, such as no more than 45% by weight, such as no more than 40% by weight, based on the total weight of the resin solids of the electrodepositable coating composition. The curing agent may be present in the electrodepositable coating composition in an amount of 10% to 60% by weight, such as 10% to 50% by weight, such as 10% to 45% by weight, such as 10% to 40% by weight, such as 20% to 60% by weight, such as 20% to 50% by weight, such as 20% to 45% by weight, such as 20% to 40% by weight, such as 25% to 60% by weight, such as 25% to 50% by weight, such as 25% to 45% by weight, such as 25% to 40% by weight, based on the total weight of the resin solids of the electrodepositable coating composition.

According to the present disclosure, the electrodepositable coating composition further comprises a pigment. The pigment may comprise an iron oxide, a lead oxide, strontium chromate, carbon black, coal dust, titanium dioxide, barium sulfate, a color pigment, a phyllosilicate pigment, a metal pigment, a thermally conductive, electrically insulative filler, fire-retardant pigment, or any combination thereof.

As used herein, the term “phyllosilicate” refers to a group of minerals having sheets of silicates having a basic structure based on interconnected six membered rings of SiO₄⁻⁴ tetrahedra that extend outward in infinite sheets where 3 out of the 4 oxygens from each tetrahedra are shared with other tetrahedra resulting in phyllosilicates having the basic structural unit of Si₂O₅⁻². Phyllosilicates may comprise hydroxide ions located at the center of the tetrahedra and/or cations such as, for example, Fe⁺², Mg⁺², or Al⁺³, that form cation layers between the silicate sheets where the cations may coordinate with the oxygen of the silicate layer and/or the hydroxide ions. The term “phyllosilicate pigment” refers to pigment materials comprising phyllosilicates. Non-limiting examples of phyllosilicate pigments includes the micas, chlorites, serpentine, talc, and the clay minerals. The clay minerals include, for example, kaolin clay and smectite clay. The sheet-like structure of the phyllosilicate pigment tends to result in pigment having a plate-like structure, although the pigment can be manipulated (such as through mechanical means) to have other particle structures. These pigments when exposed to liquid media may or may not swell and may or may not have leachable components (e.g.: ions that may be drawn towards the aqueous medium).

The phyllosilicate pigment may comprise a plate-like pigment. For example, the phyllosilicate pigment may comprise a plate-like mica pigment, a plate-like chlorite pigment, a plate-like serpentine pigment, a plate-like talc pigment, and/or a plate-like clay pigment. The plate-like clay pigment may comprise kaolin clay, smectite clay, or a combination thereof.

As noted above, the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

The pigment-to-binder ratio of phyllosilicate pigment to the electrodepositable binder is less than 0.2:1 if the electrodepositable coating composition is a cationic electrodepositable coating composition and a pigment dispersing agent is present in the cationic electrodepositable coating composition.

The cationic electrodepositable coating composition may be substantially free, essentially free, or completely free of phyllosilicate pigment if the cationic electrodepositable coating composition comprises a pigment dispersing acid.

The cationic electrodepositable coating composition may be substantially free, essentially free, or completely free of phyllosilicate pigment if the cationic electrodepositable coating composition comprises a pigment dispersing agent.

As used herein, the term “thermally conductive, electrically insulative filler” refers to or “TC/EI filler” means a pigment, filler, or inorganic powder that has a thermal conductivity of at least 5 W/m·K at 25° C. (measured according to ASTM D7984) and a volume resistivity of at least 10 Ω·m (measured according to ASTM D257, C611, or B193). The TC/EI filler material may comprise organic or inorganic material and may comprise particles of a single type of filler material or may comprise particles of two or more types of TC/EI filler materials. That is, the TC/EI filler material may comprise particles of a first TC/EI filler material and may further comprise particles of at least a second (i.e., a second, a third, a fourth, etc.) TC/EI filler material that is different from the first TC/EI filler material. As used herein with respect to types of filler material, reference to “first,” “second”, etc. is for convenience only and does not refer to order of addition or the like.

The TC/EI filler material may have a thermal conductivity of at least 5 W/m·K at 25° C. (measured according to ASTM D7984), such as at least 18 W/m·K, such as at least 55 W/m·K. The TC/EI filler material may have a thermal conductivity of no more than 3,000 W/m·K at 25° C. (measured according to ASTM D7984), such as no more than 1,400 W/m·K, such as no more than 450 W/m·K. The TC/EI filler material may have a thermal conductivity of 5 W/m·K to 3,000 W/m·K at 25° C. (measured according to ASTM D7984), such as 18 W/m·K to 1,400 W/m·K, such as 55 W/m·K to 450 W/m·K.

The TC/EI filler material may have a volume resistivity of at least 10 Ω·m (measured according to ASTM D257, C611, or B193), such as at least 20 Ω·m, such as at least 30 Ω·m, such as at least 40 Ω·m, such as at least 50 Ω·m, such as at least 60 Ω·m, such as at least 60 Ω·m, such as at least 70 Ω·m, such as at least 80 Ω·m, such as at least 80 Ω·m, such as at least 90 Ω·m, such as at least 100 Ω·m.

Suitable non-limiting examples of TC/EI filler materials include nitrides, metal oxides, metalloid oxides, metal hydroxides, arsenides, carbides, minerals, ceramics, and diamond. For example, the TC/EI filler material may comprise, consist essentially of, or consist of boron nitride, silicon nitride, aluminum nitride, boron arsenide, aluminum oxide, magnesium oxide, dead burned magnesium oxide, beryllium oxide, silicon dioxide, titanium oxide, zinc oxide, nickel oxide, copper oxide, tin oxide, aluminum hydroxide, magnesium hydroxide, boron arsenide, silicon carbide, agate, emery, ceramic microspheres, diamond, or any combination thereof. Non-limiting examples of commercially available TC/EI filler materials of boron nitride include, for example, CarboTherm from Saint-Gobain, CoolFlow and PolarTherm from Momentive, and as hexagonal boron nitride powder available from Panadyne; of aluminum nitride, for example, aluminum nitride powder available from Micron Metals Inc., and as Toyalnite from Toyal; of aluminum oxide include, for example, Microgrit from Micro Abrasives, Nabalox from Nabaltec, Aeroxide from Evonik, and as Alodur from Imerys; of dead burned magnesium oxide include, for example, MagChem® P98 from Martin Marietta Magnesia Specialties; of aluminum hydroxide include, for example, APYRAL from Nabaltec GmbH and aluminum hydroxide from Sibelco; and of ceramic microspheres include, for example, ceramic microspheres from Zeeospheres Ceramics or 3M. These fillers can also be surface modified. For example, surface modified magnesium oxide available as PYROKISUMA 5301K available from Kyowa Chemical Industry Co., Ltd. Alternatively, the TC/EI filler materials may be free of any surface modification.

The TC/EI filler material may have any particle shape or geometry. For example, the TC/EI filler material may be a regular or irregular shape and may be spherical, ellipsoidal, cubical, platy, acicular (elongated or fibrous), rod-shaped, disk-shaped, prism-shaped, flake-shaped, irregular, rock-like, etc., agglomerates thereof, and any combination thereof.

Particles of TC/EI filler material may have a reported average particle size in at least one dimension of at least 0.01 microns, as reported by the manufacturer, such as at least 2 microns, such as at least 10 microns. Particles of TC/EI filler material may have a reported average particle size in at least one dimension of up to 100 microns or more, such as no more than 100 microns, such as no more than 50 microns, such as no more than 40 microns, such as no more than 25 microns. The particles of TC/EI filler material may have a reported average particle size in at least one dimension of 0.01 microns to 100 microns as reported by the manufacturer, such as 0.01 microns to 50 microns, such as 0.01 microns to 40 microns, such as 0.01 microns to 25 microns, such as 2 microns to 100 microns, such as 2 microns to 50 microns, such as 2 microns to 40 microns, such as 2 microns to 25 microns, such as 10 micron to 100 microns, such as 10 microns to 50 microns, such as 10 microns to 40 microns, such as 10 microns to 25 microns. Suitable methods of measuring average particle size include, for example, measurement using an instrument such as the Quanta 250 FEG SEM or an equivalent instrument.

Particles of TC/EI filler material of the electrodepositable coating composition may have a reported Mohs hardness of at least 1 (based on the Mohs Hardness Scale), such as at least 2, such as at least 3. Particles of TC/EI filler material of the electrodepositable coating composition may have a reported Mohs hardness of no more than 10, such as no more than 8, such as no more than 7. Particles of TC/EI filler material of the electrodepositable coating composition may have a reported Mohs hardness of 1 to 10, such as 2 to 8, such as 3 to 7.

As used herein, “flame retardant” refers to a material that slows down or stops the spread of fire or reduces its intensity. Flame retardants may be available as a powder that may be mixed with a composition, a foam, or a gel. In examples, when the compositions of the present disclosure include a flame retardant, such compositions may form a coating on a substrate surface and such coating may function as a flame retardant.

As set forth in more detail below, a flame retardant can include a mineral, an organic compound, an organohalogen compound, an organophosphorous compound, or a combination thereof.

Suitable examples of minerals include huntite, hydromagnesite, various hydrates, red phosphorous, boron compounds such as borates, carbonates such as calcium carbonate and magnesium carbonate, and combinations thereof.

Suitable examples of organohalogen compounds include organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Such halogenated flame retardants may be used in conjunction with a synergist to enhance their efficiency. Other suitable examples include antimony trioxide, antimony pentaoxide, and sodium antimonate.

Suitable examples of organophosphorous compounds include triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6).

Suitable examples of organic compounds include carboxylic acid, dicarboxylic acid, melamine, and organonitrogen compounds.

Other suitable flame retardants include ammonium polyphosphate and barium sulfate.

According to the present disclosure, the pigment may have any particle shape or geometry. For example, the pigment may be a regular or irregular shape and may be spherical, ellipsoidal, cubical, platy, acicular (elongated or fibrous), rod-shaped, disk-shaped, prism-shaped, flake-shaped, irregular, rock-like, etc., agglomerates thereof, and any combination thereof.

The pigment may have a reported average particle size in at least one dimension of at least 0.01 microns, as reported by the manufacturer, such as at least 2 microns, such as at least 10 microns. The pigment may have a reported average particle size in at least one dimension of up to 100 microns or more, such as no more than 100 microns, such as no more than 50 microns, such as no more than 40 microns, such as no more than 25 microns. The pigment may have a reported average particle size in at least one dimension of 0.01 microns to 100 microns as reported by the manufacturer, such as 0.01 microns to 50 microns, such as 0.01 microns to 40 microns, such as 0.01 microns to 25 microns, such as 2 microns to 100 microns, such as 2 microns to 50 microns, such as 2 microns to 40 microns, such as 2 microns to 25 microns, such as 10 micron to 100 microns, such as 10 microns to 50 microns, such as 10 microns to 40 microns, such as 10 microns to 25 microns. Suitable methods of measuring average particle size include, for example, measurement using an instrument such as the Quanta 250 FEG SEM or an equivalent instrument.

According to the present disclosure, the electrodepositable coating composition is substantially free, essentially free, or completely free of metal pigment.

According to the present disclosure, the electrodepositable coating composition is substantially free, essentially free, or completely free of electrically conductive pigment.

According to the present disclosure, the electrodepositable coating composition may optionally further comprise a pigment dispersing additive that functions to both improve dispersion of the pigment and increase the viscosity of the electrodepositable binder and electrodepositable coating composition. The improvement in pigment dispersion may be demonstrated by reduced pigment grinding time or energy necessary to achieve a Hegman reading of at least 5.

As used herein, the term “dispersed pigment” or “pigment dispersion” refers pigment that has been deagglomerated in a liquid medium. The degree of pigment dispersion and/or deagglomeration may be measured using a Hegman gauge.

The pigment dispersing additive optionally may comprise a phyllosilicate pigment dispersing agent. As used herein, the term “phyllosilicate pigment dispersing agent” refers to a material capable of forming a chemical complex with the phyllosilicate pigment and may assist in promoting dispersion of the phyllosilicate pigment. The complex may be referred to as a phyllosilicate pigment dispersing agent-phyllosilicate pigment complex.

Alternatively, the electrodepositable coating composition may be substantially free, essentially free, or completely free of a phyllosilicate pigment dispersing agent. As used herein, an electrodepositable coating composition is substantially free of a phyllosilicate pigment dispersing agent if the phyllosilicate pigment dispersing agent is present, if at all, in an amount of less than 1% by weight, based on the total solids weight of the composition. As used herein, an electrodepositable coating composition is essentially free of a phyllosilicate pigment dispersing agent if the phyllosilicate pigment dispersing agent is present, if at all, in an amount of less than 0.1% by weight, based on the total solids weight of the composition. As used here, an electrodepositable coating composition is completely free of a phyllosilicate pigment dispersing agent if the phyllosilicate pigment dispersing agent is not present in the composition, i.e., 0.00% by weight, based on the total solids weight of the composition.

Alternatively, the electrodepositable coating composition may be substantially free, essentially free, or completely free of a phyllosilicate pigment dispersing agent-phyllosilicate pigment complex. As used herein, an electrodepositable coating composition is substantially free of a phyllosilicate pigment dispersing agent-phyllosilicate pigment complex if the phyllosilicate pigment dispersing agent-phyllosilicate pigment complex is present, if at all, in an amount of less than 1% by weight, based on the total solids weight of the composition. As used herein, an electrodepositable coating composition is essentially free of a phyllosilicate pigment dispersing agent-phyllosilicate pigment complex if the phyllosilicate pigment dispersing agent-phyllosilicate pigment complex is present, if at all, in an amount of less than 0.1% by weight, based on the total solids weight of the composition. As used here, an electrodepositable coating composition is completely free of a phyllosilicate pigment dispersing agent-phyllosilicate pigment complex if the phyllosilicate pigment dispersing agent-phyllosilicate pigment complex is not present in the composition, i.e., 0.00% by weight, based on the total solids weight of the composition.

As used herein, the dispersing additive may comprise a material capable of forming a chemical complex with the pigment, and the pigment dispersing additive optionally may comprise a material capable of forming a chemical complex with the pigment or physical interaction with the pigment and may optionally form a pigment dispersing additive-pigment complex.

The pigment dispersing additive may comprise a pigment dispersing acid. In cationic electrodepositable coating compositions, the pigment dispersing acid is present in addition to any solubilizing acids used to disperse and/or solubilize the resinous components of the electrodepositable binder and/or acids added to adjust the pH of the composition, and the pigment dispersing acid may form a chemical complex or physical interaction with the pigment. The pigment dispersing acid may be a monoprotic acid or polyprotic acid. As used herein, the term “polyprotic acid” refers to chemical compounds having more than one acidic proton. As used herein, the term “acidic proton” refers to a proton that forms part of an acid group, including, but not limited to, oxyacids of phosphorus, carboxylic acids, oxyacids of sulfur, and the like.

The pigment dispersing acid may comprise a first acidic proton having a pKa of at least 1.1, such as at least 1.5, such as at least 1.8. The pigment dispersing acid may comprise a first acidic proton having a pKa of no more than 4.6, such as no more than 4.0, such as no more than 3.5. The pigment dispersing acid may comprise a first acidic proton having a pKa of 1.1 to 4.6, such as 1.5 to 4.0, such as 1.8 to 3.5.

The pigment dispersing acid may comprise a carboxylic acid, an oxyacid of phosphorus (such as phosphoric acid or phosphonic acid), or a combination thereof.

The ratio of the weight of pigment to moles of pigment dispersing additive may be at least 0.25 g/mmol, such as at least 0.5 g/mmol, such as at least 1.0 g/mmol, such as at least 1.5 g/mmol, such as at least 1.75 g/mmol. The ratio of the weight of pigment to moles of pigment dispersing additive may be no more than 25 g/mmol, such as no more than 15 g/mmol, such as no more than 10 g/mmol, such as no more than 8.25 g/mmol, such as no more than 6.5 g/mmol, such as no more than 5.0 g/mmol. The ratio of the weight of pigment to moles of pigment dispersing additive may be in the amount of 0.25 to 25 g/mmol, such as 0.25 to 15 g/mmol, such as 0.25 to 10 g/mmol, such as 0.25 to 8.25 g/mmol, such as 0.25 to 6.5 g/mmol, such as 0.25 to 5.0 g/mmol, such as 0.5 to 25 g/mmol, such as 0.5 to 15 g/mmol, such as 0.5 to 10 g/mmol, such as 0.5 to 8.25 g/mmol, such as 0.5 to 6.5 g/mmol, such as 0.5 to 5.0 g/mmol, such as 1 to 25 g/mmol, such as 1 to 15 g/mmol, such as 1 to 10 g/mmol, such as 1 to 8.25 g/mmol, such as 1 to 6.5 g/mmol, such as 1 to 5.0 g/mmol, such as 1.5 to 25 g/mmol, such as 1.5 to 15 g/mmol, such as 1.5 to 10 g/mmol, such as 1.5 to 8.25 g/mmol, such as 1.5 to 6.5 g/mmol, such as 1.5 to 5.0 g/mmol, such as 1.75 to 25 g/mmol, such as 1.75 to 15 g/mmol, such as 1.75 to 10 g/mmol, such as 1.75 to 8.25 g/mmol, such as 1.75 to 6.5 g/mmol, such as 1.75 to 5.0 g/mmol.

The pigment-to-binder (P:B) ratio as set forth in this disclosure may refer to the weight ratio of the pigment-to-binder in the electrodepositable coating composition, and/or the weight ratio of the pigment-to-binder in the deposited wet film, and/or the weight ratio of the pigment to the binder in the dry, uncured deposited film, and/or the weight ratio of the pigment-to-binder in the cured film. The pigment-to-binder (P:B) ratio of the pigment to the electrodepositable binder may be at least 0.30:1, such as at least 0.35:1, such as at least 0.40:1, such as at least 0.50:1, such as at least 0.60:1, such as at least 0.75:1, such as at least 1:1, such as at least 1.25:1, such as at least 1.5:1. The pigment-to-binder (P:B) ratio of the pigment to the electrodepositable binder may be no more than 2.0:1, such as no more than 1.75:1, such no more than 1.5:1, such as no more than 1.25:1, such as no more than 1:1, such as no more than 0.75:1, such as no more than 0.70:1, such as no more than 0.60:1, such as no more than 0.55:1, such as no more than 0.50:1. The pigment-to-binder (P:B) ratio of the pigment to the electrodepositable binder may be 0.3:1 to 2.0:1, such as 0.3:1 to 1.75:1, such as 0.3:1 to 1.50:1, such as 0.3:1 to 1.25:1, such as 0.3:1 to 1:1, such as 0.3:1 to 0.75:1, such as 0.3:1 to 0.70:1, such as 0.3:1 to 0.60:1, such as 0.3:1 to 0.55:1, such as 0.3:1 to 0.50:1, such as 0.35:1 to 2.0:1, such as 0.35:1 to 1.75:1, such as 0.35:1 to 1.50:1, such as 0.35:1 to 1.25:1, such as 0.35:1 to 1:1, such as 0.35:1 to 0.75:1, such as 0.35:1 to 0.70:1, such as 0.35:1 to 0.60:1, such as 0.35:1 to 0.55:1, such as 0.35:1 to 0.50:1, such as 0.4:1 to 2.0:1, such as 0.4:1 to 1.75:1, such as 0.4:1 to 1.50:1, such as 0.4:1 to 1.25:1, such as 0.4:1 to 1:1, such as 0.4:1 to 0.75:1, such as 0.4:1 to 0.70:1, such as 0.4:1 to 0.60:1, such as 0.4:1 to 0.55:1, such as 0.4:1 to 0.50:1, such as 0.5:1 to 2.0:1, such as 0.5:1 to 1.75:1, such as 0.5:1 to 1.50:1, such as 0.5:1 to 1.25:1, such as 0.5:1 to 1:1, such as 0.5:1 to 0.75:1, such as 0.5:1 to 0.70:1, such as 0.5:1 to 0.60:1, such as 0.5:1 to 0.55:1, such as 0.6:1 to 2.0:1, such as 0.6:1 to 1.75:1, such as 0.6:1 to 1.50:1, such as 0.6:1 to 1.25:1, such as 0.6:1 to 1:1, such as 0.6:1 to 0.75:1, such as 0.6:1 to 0.70:1, such as 0.75:1 to 2.0:1, such as 0.75:1 to 1.75:1, such as 0.75:1 to 1.50:1, such as 0.75:1 to 1.25:1, such as 0.75:1 to 1:1, such as 1:1 to 2.0:1, such as 1:1 to 1.75:1, such as 1:1 to 1.50:1, such as 1:1 to 1.25:1, such as 1.25:1 to 2.0:1, such as 1.25:1 to 1.75:1, such as 1.25:1 to 1.50:1, such as 1.50:1 to 2.0:1, such as 1.50:1 to 1.75:1.

The pigment dispersing additive may be present in an amount of at least 0.1% by weight, such as at least 0.3% by weight, such as at least 0.5% by weight, such as at least 0.7% by weight, such as at least 0.8% by weight, such as 1% by weight, based on the total solids weight of the composition. The pigment dispersing additive may be present in an amount of no more than 10% by weight, such as no more than 7.5% by weight, such as no more than 5% by weight, such as no more than 3% by weight, such as no more than 2% by weight, such as no more than 1.5% by weight, such as no more than 1% by weight, such as no more than 0.8% by weight, based on the total solids weight of the composition. The pigment dispersing additive may be present in an amount of 0.1% to 10% by weight, such as 0.1% to 7.5% by weight, such as 0.1% to 5% by weight, such as 0.1% to 3% by weight, such as 0.1% to 2% by weight, such as 0.1% to 1.5% by weight, such as 0.1% to 1% by weight, such as 0.1% to 0.8% by weight, such as 0.3% to 10% by weight, such as 0.3% to 7.5% by weight, such as 0.3% to 5% by weight, such as 0.3% to 3% by weight, such as 0.3% to 2% by weight, such as 0.3% to 1.5% by weight, such as 0.3% to 1% by weight, such as 0.3% to 0.8% by weight, such as 0.5% to 10% by weight, such as 0.5% to 7.5% by weight, such as 0.5% to 5% by weight, such as 0.5% to 3% by weight, such as 0.5% to 2% by weight, such as 0.5% to 1.5% by weight, such as 0.5% to 1% by weight, such as 0.5% to 0.8% by weight, such as 0.7% to 10% by weight, such as 0.7% to 7.5% by weight, such as 0.7% to 5% by weight, such as 0.7% to 3% by weight, such as 0.7% to 2% by weight, such as 0.7% to 1.5% by weight, such as 0.7% to 1% by weight, such as 0.7% to 0.8% by weight, such as 0.8% to 10% by weight, such as 0.8% to 7.5% by weight, such as 0.8% to 5% by weight, such as 0.8% to 3% by weight, such as 0.8% to 2% by weight, such as 0.8% to 1.5% by weight, such as 0.8% to 1% by weight, such as 1% to 10% by weight, such as 1% to 7.5% by weight, such as 1% to 5% by weight, such as 1% to 3% by weight, such as 1% to 2% by weight, such as 1% to 1.5% by weight, such as 1% to 1% by weight, such as 1% to 0.8% by weight, based on the total solids weight of the composition.

According to the present disclosure, the electrodepositable coating composition may be substantially free, essentially free, or completely free of pigment dispersing agent. As used herein, an electrodepositable coating composition is substantially free of a pigment dispersing agent if the pigment dispersing agent is present, if at all, in an amount of less than 1% by weight, based on the total solids weight of the composition. As used herein, an electrodepositable coating composition is essentially free of a pigment dispersing agent if the pigment dispersing agent is present, if at all, in an amount of less than 0.1% by weight, based on the total solids weight of the composition. As used here, an electrodepositable coating composition is completely free of a pigment dispersing agent if the pigment dispersing agent is not present in the composition, i.e., 0.00% by weight, based on the total solids weight of the composition.

According to the present disclosure, the electrodepositable coating composition may be substantially free, essentially free, or completely free of pigment dispersing acid. As used herein, an electrodepositable coating composition is substantially free of pigment dispersing acid if pigment dispersing acid is present, if at all, in an amount of less than 1% by weight, based on the total solids weight of the composition. As used herein, an electrodepositable coating composition is essentially free of pigment dispersing acid if pigment dispersing acid is present, if at all, in an amount of less than 0.1% by weight, based on the total solids weight of the composition. As used here, an electrodepositable coating composition is completely free of pigment dispersing acid if pigment dispersing acid is not present in the composition, i.e., 0.00% by weight, based on the total solids weight of the composition.

According to the present disclosure, the electrodepositable coating composition may be substantially free, essentially free, or completely free of silane dispersant. As used herein, an electrodepositable coating composition is substantially free of silane dispersant if silane dispersant is present, if at all, in an amount of less than 1% by weight, based on the total solids weight of the composition. As used herein, an electrodepositable coating composition is essentially free of silane dispersant if silane dispersant is present, if at all, in an amount of less than 0.1% by weight, based on the total solids weight of the composition. As used here, an electrodepositable coating composition is completely free of silane dispersant if silane dispersant is not present in the composition, i.e., 0.00% by weight, based on the total solids weight of the composition.

According to the present disclosure, the electrodepositable coating composition may be substantially free, essentially free, or completely free of electrically conductive particles. The electrically conductive particles may comprise any particles capable of conducting electricity. As used herein, an electrically conductive particle is “capable of conducting electricity” if the material has a conductivity of at least 1×10⁵ S/m and a resistivity of no more than 1×10⁶ W-m at 20° C. The electrically conductive particles may include carbonaceous materials such as, activated carbon, carbon black such as acetylene black and furnace black, graphene, carbon nanotubes, including single-walled carbon nanotubes and/or multi-walled carbon nanotubes, carbon fibers, fullerene, metal particles, and combinations thereof. As used herein, an electrodepositable coating composition is substantially free of electrically conductive particles if electrically conductive particles are present in an amount of less than 5% by weight, based on the total weight of the pigment of the composition. As used herein, an electrodepositable coating composition is essentially free of electrically conductive particles if electrically conductive particles are present in an amount of less than 1% by weight, based on the total weight of the pigment of the composition. As used here, an electrodepositable coating composition is completely free of electrically conductive particles if electrically conductive particles are not present in the composition, i.e., 0.00% by weight, based on the total weight of the pigment of the composition.

According to the present disclosure, the electrodepositable coating composition may be substantially free, essentially free, or completely free of metal particles. As used herein, the term “metal particles” refers to metal and metal alloy pigments that consist primarily of metal(s) in the elemental (zerovalent) state. The metal particles may include zinc, aluminum, cadmium, magnesium, beryllium, copper, silver, gold, iron, titanium, nickel, manganese, chromium, scandium, yttrium, zirconium, platinum, tin, and alloys thereof, as well as various grades of steel. As used herein, an electrodepositable coating composition is substantially free of metal particles if metal particles are present in an amount of less than 5% by weight, based on the total weight of the pigment of the composition. As used herein, an electrodepositable coating composition is essentially free of metal particles if metal particles are present in an amount of less than 1% by weight, based on the total weight of the pigment of the composition. As used here, an electrodepositable coating composition is completely free of metal particles if metal particles are not present in the composition, i.e., 0.00% by weight, based on the total weight of the pigment of the composition.

According to the present disclosure, the electrodepositable coating composition of the present disclosure may be substantially free, essentially free, or completely free of lithium-containing compounds. As used herein, lithium-containing compounds refers to compounds or complexes that comprise lithium, such as, for example, LiCoC, LiNIC, LiFePO₄, LiCOPCO₄, LiMnO₂, LiMn₂O₄, Li(NiMnCo)O₂, and Li(NiCoAl)O₂. As used herein, an electrodepositable coating composition is “substantially free” of lithium-containing compounds if lithium-containing compounds are present in the electrodepositable coating composition in an amount of less than 1% by weight, based on the total solids weight of the composition. As used herein, an electrodepositable coating composition is “essentially free” of lithium-containing compounds if lithium-containing compounds are present in the electrodepositable coating composition in an amount of less than 0.1% by weight, based on the total solids weight of the composition. As used herein, an electrodepositable coating composition is “completely free” of lithium-containing compounds if lithium-containing compounds are not present in the electrodepositable coating composition, i.e., <0.001% by weight, based on the total solids weight of the composition.

According to the present disclosure, the electrodepositable coating composition optionally may be substantially free, essentially free, or completely free of a grind resin. As used herein, the term “grind resin” refers to a resin chemically distinct from the main film-forming polymer that is used during milling of pigment to form a pigment paste separately from the main film-forming polymer of the binder. For example, the grind resin may include quaternary ammonium salt groups and/or tertiary sulfonium groups. As used herein, an electrodepositable coating composition is substantially free of grind resin if grind resin is present, if at all, in an amount of no more than 5% by weight, based on the total resin solids weight of the composition. As used herein, an electrodepositable coating composition is essentially free of grind resin if grind resin is present, if at all, in an amount no more than 3% by weight, based on the total resin solids weight of the composition. As used here, an electrodepositable coating composition is completely free of grind resin if grind resin is not present in the composition, i.e., 0.00% by weight, based on the total resin solids weight of the composition.

The electrodepositable coating composition according to the present disclosure may optionally comprise one or more further components in addition to the ionic salt group-containing film-forming polymer and the curing agent described above.

According to the present disclosure, the electrodepositable coating composition may optionally comprise a catalyst to catalyze the reaction between the curing agent and the polymers. Examples of catalysts suitable for cationic electrodepositable coating compositions include, without limitation, organotin compounds (e.g., dibutyltin oxide and dioctyltin oxide) and salts thereof (e.g., dibutyltin diacetate); other metal oxides (e.g., oxides of cerium, zirconium and bismuth) and salts thereof (e.g., bismuth sulfamate and bismuth lactate); or a cyclic guanidine as described in U.S. Pat. No. 7,842,762 at col. 1, line 53 to col. 4, line 18 and col. 16, line 62 to col. 19, line 8, the cited portions of which being incorporated herein by reference. Examples of catalysts suitable for anionic electrodepositable coating compositions include latent acid catalysts, specific examples of which are identified in WO 2007/118024 at and include, but are not limited to, ammonium hexafluoroantimonate, quaternary salts of SbF₆ (e.g., NACURE® XC-7231), t-amine salts of SbF₆ (e.g., NACURE® XC-9223), Zn salts of triflic acid (e.g., NACURE® A202 and A218), quaternary salts of triflic acid (e.g., NACURE® XC-A230), and diethylamine salts of triflic acid (e.g., NACURE® A233), all commercially available from King Industries, and/or mixtures thereof. Latent acid catalysts may be formed by preparing a derivative of an acid catalyst such as para-toluenesulfonic acid (pTSA) or other sulfonic acids. For example, a well-known group of blocked acid catalysts are amine salts of aromatic sulfonic acids, such as pyridinium para-toluenesulfonate. Such sulfonate salts are less active than the free acid in promoting crosslinking. During cure, the catalysts may be activated by heating.

According to the present disclosure, the electrodepositable coating composition optionally may comprise a rheology modifier. As used herein, the term “rheology modifier” refers to a material that, when added to the electrodepositable coating composition, modifies, for example, the rheological properties of a fluid, such as imparting shear thinning properties, shear thickening properties, thixotropic properties, and the like. The rheology modifier may assist in preventing settling of the electrodepositable coating composition, and the rheology modifier may further improve the uniformity of an electrodeposited coating produced by electrodepositing the electrodepositable coating composition. The rheology modifier may comprise, for example, one or more cellulose derivatives, one or more alkali-swellable rheology modifier, one or more acid-swellable rheology modifier, one or more hydrophobically modified urethane-ethoxylate (HEUR) associative thickeners, colloidal layered silicate, smectite clay, fumed silicas, or the like.

The cellulose derivative may comprise any known in the art for modifying the rheology of electrodepositable coating compositions. For example, the cellulose derivative may comprise carboxymethylcellulose and salts thereof, microcrystalline cellulose, nanocrystalline cellulose, and other cellulose-based compounds. Non-limiting examples of suitable commercially available cellulose-based compounds include CRYSTO Cellulose, available from Renmatix, Inc., which is a highly crystalline cellulose derivative having a particle size ranging 0.5 to 1.5 pm and provides properties of both microcrystalline cellulose and advanced nanocrystalline cellulose in parallel.

The rheology modifier may comprise an alkali-swellable rheology modifier. Non-limiting examples of alkali-swellable rheology modifiers include alkali-swellable emulsions (ASE), hydrophobically modified alkali-swellable emulsions (HASE), ATRP star polymers, and other materials that provide pH-triggered rheological changes at low pH. Commercially available alkali-swellable rheology modifiers include alkali-swellable emulsions (ASE) such as ACRYSOL™ ASE60, hydrophobically modified alkali-swellable emulsions (HASE) such as ACRYSOLT HASE TT-615, and ACRYSOL™ DR-180 HASE, each of which are available from the Dow Chemical Company, and ATRP star polymers such as fracASSIST® prototype 2. The ACRYSOL ASE alkali-swellable rheology modifiers comprise a copolymer comprising (meth)acrylic acid and an acrylate ester at a ratio of about 2:1 to 1:2, such as 1.5:1 to 1:1.5, such as about 1.1:1 to 1:1.1, such as about 1:1. The ACRYSOL HASE alkali-swellable rheology modifier comprise a tertiary polymer comprising the (meth)acrylic acid and acrylate ester copolymer used in the ASE family modified with a hydrophobic acrylic ester monomer. When the acid is un-neutralized at low pH, the rheology modifier is insoluble in water and does not thicken the composition, whereas when the acid is fully neutralized at higher pH values, the rheology modifier becomes soluble and thickens the composition.

The rheology modifier may comprise a hydrophobically modified urethane-ethoxylate (HEUR) associative thickener. Non-limiting examples of hydrophobically modified urethane-ethoxylate (HEUR) associative thickener include products sold under the BORCHI Gel mark from Borchers Americas Inc., including, but not limited to, BORCHI Gel 0620, and the like.

The rheology modifier may comprise a colloidal layered silicate. Colloidal layered silicates that are suitable for use in the electrodepositable coating compositions described herein include, for example, LAPONITE RD, LAPONITE RDS, LAPONITE XL21 and LAPONITE JS, including combinations thereof. LAPONITE RD is a free-flowing synthetic layered silicate having a bulk density of 1,000 kg/m³, a surface area (BET) of 370 m²/g, a pH of a 2% suspension in water of 9.8, wherein the composition on a dry basis by weight is 59.5% SiO₂, 27.5% MgO, 0.8% Li₂O, and 2.8% Na₂O. LAPONITE RDS is also a free-flowing synthetic layered silicate having a bulk density of 1,000 kg/m³, a surface area (BET) of 330 m²/g, a pH of a 2% suspension in water of 9.7, wherein the composition on a dry basis by weight is 54.5% SiO₂, 26.0% MgO, 0.8% Li₂O, 5.6% Na₂O, and 4.1% P₂O₅. LAPONITE XL21 is sodium magnesium fluorosilicate. The particle size of the colloidal layered silicates, such as those described above, may be 1 nm to 2 μm in average diameter. Suitable methods of measuring particle sizes disclosed herein include, for example, transmission electron microscopy (TEM). Suitable methods of measuring clay particle size by TEM include suspending particles in a solvent and then drop-casting the suspension into a TEM grid which is allowed to dry under ambient conditions. For example, clay particles may be diluted in water for drop casting and measurements may be obtained from images acquired from a Tecnai T20 TEM operating at 200 kV and analyzed using ImageJ software or an equivalent solvent, instrument, and software.

As used herein, the term “smectite clay” refers to clay having a variable net negative charge which is balanced by a positive charge adsorbed externally on interlamellar surfaces.

As used herein, the term “acid-swellable rheology modifier” refers to a rheology modifier that is insoluble at high pH and does not thicken the composition and is soluble at lower pH and thickens the composition.

The rheology modifier may comprise fumed silica. Fumed silica is made from flame pyrolysis of silicon tetrachloride or from quartz sand, vaporized in a 3000° ° C. electric arc. Non-limiting examples of suitable fumed silicas include those available from Evonik Resource Efficiency GmbH (who sells it under the name AEROSIL), Cabot Corporation (Cab-O-Sil), Wacker Chemie (HDK), Dow Corning, Heraeus (Zandosil), Tokuyama Corporation (Reolosil), OCI (Konasil), Orisil (Orisil) and Xunyuchem (XYSIL).

The rheology modifier may be present in an amount of 0.5% by weight, such as at least 1% by weight, such as at least 2% by weight, such as at least 2.5% by weight, based on the total weight of the resin solids of the electrodepositable coating composition. The rheology modifier may be present in an amount of no more than 15% by weight, such as no more than 10% by weight, such as no more than 8% by weight, such as no more than 5% by weight, based on the total weight of the resin solids of the electrodepositable coating composition. The rheology modifier may be present in an amount of 0.5% to 15% by weight, such as 0.5% to 10% by weight, such as 0.5% to 8% by weight, such as 0.5% to 5% by weight, such as 1% to 15% by weight, such as 1% to 10% by weight, such as 1% to 8% by weight, such as 1% to 5% by weight, such as 2% to 15% by weight, such as 2% to 10% by weight, such as 2% to 8% by weight, such as 2% to 5% by weight, such as 2.5% to 15% by weight, such as 2.5% to 10% by weight, such as 2.5% to 8% by weight, such as 2.5% to 5% by weight, based on the total weight of the resin solids of the electrodepositable coating composition.

According to the present disclosure, the electrodepositable coating compositions of the present disclosure may optionally comprise crater control additives which may be incorporated into the coating composition, such as, for example, a polyalkylene oxide polymer which may comprise a copolymer of butylene oxide and propylene oxide. According to the present disclosure, the molar ratio of butylene oxide to propylene oxide may be at least 1:1, such as at least 3:1, such as at least 5:1, and in some instances, may be no more than 50:1, such as no more than 30:1, such as no more than 20:1. According to the present disclosure, the molar ratio of butylene oxide to propylene oxide may be 1:1 to 50:1, such as 3:1 to 30:1, such as 5:1 to 20:1.

The polyalkylene oxide polymer may comprise at least two hydroxyl functional groups, and may be monofunctional, difunctional, trifunctional, or tetrafunctional. As used herein, a “hydroxyl functional group” comprises an —OH group. For clarity, the polyalkylene oxide polymer may comprise additional functional groups in addition to the hydroxyl functional group(s). As used herein, “monofunctional,” when used with respect to the number of hydroxyl functional groups a particular monomer or polymer comprises, means a monomer or polymer comprising one (1) hydroxyl functional group per molecule. As used herein, “difunctional,” when used with respect to the number of hydroxyl functional groups a particular monomer or polymer comprises, means a monomer or polymer comprising two (2) hydroxyl functional groups per molecule. As used herein, “trifunctional,” when used with respect to the number of hydroxyl functional groups a particular monomer or polymer comprises, means a monomer or polymer comprising three (3) hydroxyl functional groups per molecule. As used herein, “tetrafunctional,” when used with respect to the number of hydroxyl functional groups a particular monomer or polymer comprises, means a monomer or polymer comprising four (4) hydroxyl functional groups per molecule.

The hydroxyl equivalent weight of the polyalkylene oxide polymer may be at least 100 g/mol, such as at least 200 g/mol, such as at least 400 g/mol, and may be no more than 2,000 g/mol, such as no more than 1,000 g/mol, such as no more than 800 g/mol. The hydroxyl equivalent weight of the polyalkylene oxide polymer may be 100 g/mol to 2,000 g/mol, such as 200 g/mol to 1,000 g/mol, such as 400 g/mol to 800 g/mol. As used herein, with respect to the polyalkylene oxide polymer, the “hydroxyl equivalent weight” is determined by dividing the molecular weight of the polyalkylene oxide polymer by the number of hydroxyl groups present in the polyalkylene oxide polymer.

The polyalkylene oxide polymer may have a z-average molecular weight (M_{z}) of at least 200 g/mol, such as at least 400 g/mol, such as at least 600 g/mol, and may be no more than 5,000 g/mol, such as no more than 3,000 g/mol, such as no more than 2,000 g/mol. According to the present disclosure, the polyalkylene oxide polymer may have a z-average molecular weight of 200 g/mol to 5,000 g/mol, such as 400 g/mol to 3,000 g/mol, such as 600 g/mol to 2,000 g/mol. As used herein, with respect to polyalkylene oxide polymers having a z-average molecular weight (M_{z}) of less than 900,000, the term “z-average molecular weight (M_{z})” means the z-average molecular weight (M_{z}) as determined by Gel Permeation Chromatography using Waters 2695 separation module with a Waters 410 differential refractometer (RI detector), polystyrene standards having molecular weights of from approximately 500 g/mol to 900,000 g/mol, tetrahydrofuran (THF) with 0.05 M lithium bromide (LiBr) as the eluent at a flow rate of 0.5 mL/min, and one Asahipak GF-510 HQ column for separation.

The polyalkylene oxide polymer may be present in the electrodepositable coating composition in an amount of at least 0.1% by weight based on the total weight of the resin blend solids, such as at least 0.5% by weight, such as at least 0.75% by weight, and in some instances, may be present in the electrodepositable coating composition in an amount of no more than 10% by weight based on the total weight of the resin blend solids, such as no more than 4% by weight, such as no more than 3% by weight. The polyalkylene oxide polymer may be present in the electrodepositable coating composition in an amount of at 0.1% by weight to 10% by weight based on the total weight of the resin blend solids, such as 0.5% by weight to 4% by weight, such as 0.75% by weight to 3% by weight.

According to the present disclosure, the electrodepositable coating composition may comprise other optional ingredients, such as a pigment composition and, if desired, various additives such as fillers, plasticizers, antioxidants, biocides, UV light absorbers and stabilizers, hindered amine light stabilizers, defoamers, fungicides, dispersing aids, flow control agents, surfactants, wetting agents, or combinations thereof. Alternatively, the electrodepositable coating composition may be completely free of any of the optional ingredients, i.e., the optional ingredient is not present in the electrodepositable coating composition. The other additives mentioned above may be present in the electrodepositable coating composition in amounts of 0.01% to 3% by weight, based on total weight of the resin solids of the electrodepositable coating composition.

According to the present disclosure, the electrodepositable coating composition comprises an aqueous medium comprising water and optionally one or more organic solvent(s). The aqueous medium be present in amounts of, for example, 40% to 90% by weight, such as 50% to 75% by weight, based on total weight of the electrodepositable coating composition. Examples of suitable organic solvents include oxygenated organic solvents, such as monoalkyl ethers of ethylene glycol, diethylene glycol, propylene glycol, and dipropylene glycol which contain from 1 to 10 carbon atoms in the alkyl group, such as the monoethyl and monobutyl ethers of these glycols. Examples of other at least partially water-miscible solvents include alcohols such as ethanol, isopropanol, butanol and diacetone alcohol. If used, the organic solvents may typically be present in an amount of less than 10% by weight, such as less than 5% by weight, based on total weight of the electrodepositable coating composition. The electrodepositable coating composition may in particular be provided in the form of a dispersion, such as an aqueous dispersion.

For example, the organic solvent may comprise an ether or polyether comprising a hydroxyl group and a terminal group having the structure —O—R, wherein R is a C₁ to C₈ alkyl group, such as a C₁ to C₄ alkyl group, such as a C₁ to C₃ alkyl group, or two terminal hydroxyl groups. The polyether may comprise a homopolymer, block copolymer, or random copolymer. For example, the polyether may comprise a homopolymer of ethylene oxide or propylene oxide, or the polyether may comprise block or random copolymer comprising a combination of ethylene oxide and propylene oxide in a block or random pattern. Such organic solvents may comprise the structure:

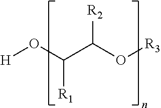

wherein R₁ and R₂ are each hydrogen or one of the R₁ and R₂ is hydrogen and the other is a methyl group; R₃ is H or a C₁ to C₈ alkyl group, such as a C₁ to C₄ alkyl group, such as a C₁ to C₃ alkyl group; and n is an integer from 1-50, such as from 1-40, such as from 1-30, such as from 1-20, such as from 1-12, such as from 1-8, such as from 1-6, such as from 1-4, such as from 2-50, such as from 2-40, such as from 2-30, such as from 2-20, such as from 2-12, such as from 2-8, such as from 2-6, such as from 2-4, such as from 3-50, such as from 3-40, such as from 3-30, such as from 3-20, such as from 3-12, such as from 3-8, such as from 3-6, such as from 3-4.

According to the present disclosure, the total solids content of the electrodepositable coating composition may be at least 1% by weight, such as at least 5% by weight, and may be no more than 50% by weight, such as no more than 40% by weight, such as no more than 20% by weight, based on the total weight of the electrodepositable coating composition. The total solids content of the electrodepositable coating composition may be from 1% to 50% by weight, such as 5% to 40% by weight, such as 5% to 20% by weight, based on the total weight of the electrodepositable coating composition. As used herein, “total solids” refers to the non-volatile content of the electrodepositable coating composition, i.e., materials which will not volatilize when heated to 110° C. for 15 minutes.

According to the present disclosure, the electrodepositable coating composition may be electrophoretically applied to a substrate. The cationic electrodepositable coating composition may be electrophoretically deposited upon any electrically conductive substrate. Suitable substrates include metal substrates, metal alloy substrates, and/or substrates that have been metallized, such as nickel-plated plastic. Additionally, substrates may comprise non-metal conductive materials including composite materials such as, for example, materials comprising carbon fibers or conductive carbon. According to the present disclosure, the metal or metal alloy may comprise cold rolled steel, hot rolled steel, steel coated with zinc metal, zinc compounds, or zinc alloys, such as electrogalvanized steel, hot-dipped galvanized steel, galvanealed steel, and steel plated with zinc alloy. Aluminum alloys of the 2XXX, 3XXX, 4XXX, 5XXX, 6XXX, or 7XXX series as well as clad aluminum alloys and cast aluminum alloys of the A356 series also may be used as the substrate. Magnesium alloys of the AZ31B, AZ91C, AM60B, or EV31A series also may be used as the substrate. The substrate used in the present disclosure may also comprise titanium and/or titanium alloys. Other suitable non-ferrous metals include copper and magnesium, as well as alloys of these materials. Suitable metal substrates for use in the present disclosure include those that are often used in the assembly of vehicular bodies (e.g., without limitation, door, body panel, trunk deck lid, roof panel, hood, roof and/or stringers, rivets, landing gear components, and/or skins used on an aircraft), a vehicular frame, vehicular parts, motorcycles, wheels, industrial structures and components such as appliances, including washers, dryers, refrigerators, stoves, dishwashers, and the like, agricultural equipment, lawn and garden equipment, air conditioning units, heat pump units, lawn furniture, and other articles. As used herein, “vehicle” or variations thereof includes, but is not limited to, civilian, commercial and military aircraft, and/or land vehicles such as cars, motorcycles, and/or trucks. The metal substrate also may be in the form of, for example, a sheet of metal or a fabricated part. It will also be understood that the substrate may be pretreated with a pretreatment solution including a zinc phosphate pretreatment solution such as, for example, those described in U.S. Pat. Nos. 4,793,867 and 5,588,989, or a zirconium containing pretreatment solution such as, for example, those described in U.S. Pat. Nos. 7,749,368 and 8,673,091.

The present disclosure is also directed to methods for coating a substrate, such as any one of the electroconductive substrates mentioned above. According to the present disclosure such method may comprise electrophoretically applying an electrodepositable coating composition as described above to at least a portion of the substrate and curing the coating composition to form an at least partially cured coating on the substrate. According to the present disclosure, the method may comprise (a) electrophoretically depositing onto at least a portion of the substrate an electrodepositable coating composition of the present disclosure and (b) heating the coated substrate to a temperature and for a time sufficient to cure the electrodeposited coating on the substrate. According to the present disclosure, the method may optionally further comprise (c) applying directly to the at least partially cured electrodeposited coating one or more pigment-containing coating compositions and/or one or more pigment-free coating compositions to form a topcoat over at least a portion of the at least partially cured electrodeposited coating, and (d) heating the coated substrate of step (c) to a temperature and for a time sufficient to cure the topcoat.

According to the present disclosure, the cationic electrodepositable coating composition of the present disclosure may be deposited upon an electrically conductive substrate by placing the composition in contact with an electrically conductive cathode and an electrically conductive anode, with the surface to be coated being the cathode. Following contact with the composition, an adherent film of the coating composition is deposited on the cathode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the cationic electrodepositable coating composition is electrodeposited over at least a portion of the electroconductive substrate, the coated substrate is heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 250° F. to 450° F. (121.1° ° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, the film thickness of the electrodeposited coating, level and type of catalyst present in the composition and the like. For purposes of the present disclosure, all that is necessary is that the time be sufficient to effect cure of the coating on the substrate. For example, the curing time can range from 10 minutes to 60 minutes, such as 20 to 40 minutes. The thickness of the resultant cured electrodeposited coating may range from 15 to 50 microns.

According to the present disclosure, the anionic electrodepositable coating composition of the present disclosure may be deposited upon an electrically conductive substrate by placing the composition in contact with an electrically conductive cathode and an electrically conductive anode, with the surface to be coated being the anode. Following contact with the composition, an adherent film of the coating composition is deposited on the anode when a sufficient voltage is impressed between the electrodes. The conditions under which the electrodeposition is carried out are, in general, similar to those used in electrodeposition of other types of coatings. The applied voltage may be varied and can be, for example, as low as one volt to as high as several thousand volts, such as between 50 and 500 volts. The current density may be between 0.5 ampere and 15 amperes per square foot and tends to decrease during electrodeposition indicating the formation of an insulating film.

Once the anionic electrodepositable coating composition is electrodeposited over at least a portion of the electroconductive substrate, the coated substrate may be heated to a temperature and for a time sufficient to at least partially cure the electrodeposited coating on the substrate. As used herein, the term “at least partially cured” with respect to a coating refers to a coating formed by subjecting the coating composition to curing conditions such that a chemical reaction of at least a portion of the reactive groups of the components of the coating composition occurs to form a coating. The coated substrate may be heated to a temperature ranging from 200° F. to 450° F. (93° ° C. to 232.2° C.), such as from 275° F. to 400° F. (135° C. to 204.4° C.), such as from 300° F. to 360° F. (149° C. to 180° C.). The curing time may be dependent upon the curing temperature as well as other variables, for example, film thickness of the electrodeposited coating, level and type of catalyst present in the composition and the like. For purposes of the present disclosure, all that is necessary is that the time be sufficient to effect cure of the coating on the substrate. For example, the curing time may range from 10 to 60 minutes, such as 20 to 40 minutes. The thickness of the resultant cured electrodeposited coating may range from 15 to 50 microns.

The electrodepositable coating compositions of the present disclosure may also, if desired, be applied to a substrate using non-electrophoretic coating application techniques, such as flow, dip, spray and roll coating applications. For non-electrophoretic coating applications, the coating compositions may be applied to conductive substrates as well as non-conductive substrates such as glass, wood and plastic.

The present disclosure is further directed to a coating formed by at least partially curing the electrodepositable coating composition described herein.

The present disclosure is further directed to a substrate that is coated, at least in part, with the electrodepositable coating composition described herein in an at least partially cured state. The coated substrate may comprise a coating comprising an ionic salt group-containing film-forming polymer and a curing agent.

The present disclosure is also directed to a substrate comprising an electrodeposited coating layer comprising an electrodepositable binder and a pigment, wherein the electrodeposited coating layer has a pigment-to-binder ratio of at least 0.3:1 and the electrodeposited coating layer has a horizontal surface roughness of less than 90 microinches, as measured by the L-PANEL SURFACE ROUGHNESS TEST METHOD.

The electrodepositable coating compositions of the present disclosure may be utilized in an electrocoating layer that is part of a multi-layer coating composite comprising a substrate with various coating layers. The coating layers may include a pretreatment layer, such as a phosphate layer (e.g., zinc phosphate layer), an electrocoating layer which results from the aqueous resinous dispersion of the present disclosure, and suitable topcoat layers (e.g., base coat, clear coat layer, pigmented monocoat, and color-plus-clear composite compositions). It is understood that suitable topcoat layers include any of those known in the art, and each independently may be waterborne, solventborne, in solid particulate form (i.e., a powder coating composition), or in the form of a powder slurry. The topcoat typically includes a film-forming polymer, crosslinking material and, if a colored base coat or monocoat, one or more pigments. According to the present disclosure, the primer layer is disposed between the electrocoating layer and the base coat layer. According to the present disclosure, one or more of the topcoat layers are applied onto a substantially uncured underlying layer. For example, a clear coat layer may be applied onto at least a portion of a substantially uncured basecoat layer (wet-on-wet), and both layers may be simultaneously cured in a downstream process.

Moreover, the topcoat layers may be applied directly onto the electrodepositable coating layer. In other words, the substrate lacks a primer layer. For example, a basecoat layer may be applied directly onto at least a portion of the electrodepositable coating layer.

It will also be understood that the topcoat layers may be applied onto an underlying layer despite the fact that the underlying layer has not been fully cured. For example, a clearcoat layer may be applied onto a basecoat layer even though the basecoat layer has not been subjected to a curing step. Both layers may then be cured during a subsequent curing step thereby eliminating the need to cure the basecoat layer and the clearcoat layer separately.

According to the present disclosure, additional ingredients such as colorants and fillers may be present in the various coating compositions from which the topcoat layers result. Any suitable colorants and fillers may be used. For example, the colorant may be added to the coating in any suitable form, such as discrete particles, dispersions, solutions and/or flakes. A single colorant or a mixture of two or more colorants can be used in the coatings of the present disclosure. It should be noted that, in general, the colorant can be present in a layer of the multi-layer composite in any amount sufficient to impart the desired property, visual and/or color effect.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant may be organic or inorganic and may be agglomerated or non-agglomerated. Colorants may be incorporated into the coatings by grinding or simple mixing. Colorants may be incorporated by grinding into the coating by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPP red BO”), titanium dioxide, carbon black, zinc oxide, antimony oxide, etc. and organic or inorganic UV opacifying pigments such as iron oxide, transparent red or yellow iron oxide, phthalocyanine blue and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

The colorant may be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions may include colorants such as pigments or dyes having a particle size of less than 150 nm, such as less than 70 nm, or less than 30 nm. Nanoparticles may be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions may also be produced by crystallization, precipitation, gas phase condensation, and chemical attrition (i.e., partial dissolution). In order to minimize re-agglomeration of nanoparticles within the coating, a dispersion of resin-coated nanoparticles may be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. patent application Ser. No. 10/876,031 filed Jun. 24, 2004, which is incorporated herein by reference, and U.S. Provisional Pat. Application No. 60/482,167 filed Jun. 24, 2003, which is also incorporated herein by reference.

According to the present disclosure, special effect compositions that may be used in one or more layers of the multi-layer coating composite include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions may provide other perceptible properties, such as reflectivity, opacity or texture. For example, special effect compositions may produce a color shift, such that the color of the coating changes when the coating is viewed at different angles. Example color effect compositions are identified in U.S. Pat. No. 6,894,086, incorporated herein by reference. Additional color effect compositions may include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

According to the present disclosure, a photosensitive composition and/or photochromic composition, which reversibly alters its color when exposed to one or more light sources, can be used in a number of layers in the multi-layer composite. Photochromic and/or photosensitive compositions can be activated by exposure to radiation of a specified wavelength. When the composition becomes excited, the molecular structure is changed, and the altered structure exhibits a new color that is different from the original color of the composition. When the exposure to radiation is removed, the photochromic and/or photosensitive composition can return to a state of rest, in which the original color of the composition returns. For example, the photochromic and/or photosensitive composition may be colorless in a non-excited state and exhibit a color in an excited state. Full color-change may appear within milliseconds to several minutes, such as from 20 seconds to 60 seconds. Example photochromic and/or photosensitive compositions include photochromic dyes.

According to the present disclosure, the photosensitive composition and/or photochromic composition may be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are identified in U.S. patent application Ser. No. 10/892,919 filed Jul. 16, 2004 and incorporated herein by reference.

As used herein, unless otherwise defined, the term “substantially free” means that the component is present, if at all, in an amount of less than 1% by weight, based on the total resin solids weight of the composition.

As used herein, unless otherwise defined, the term “essentially free” means that the component is present, if at all, in an amount of less than 0.1% by weight, based on the total resin solids weight of the composition.

As used herein, unless otherwise defined, the term “completely free” means that the component is not present in the composition, i.e., 0.00% by weight, based on the total resin solids weight of the composition.

For purposes of this detailed description, it is to be understood that the disclosure may assume alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, “including,” “containing” and like terms are understood in the context of this application to be synonymous with “comprising” and are therefore open-ended and do not exclude the presence of additional undescribed or unrecited elements, materials, ingredients or method steps. As used herein, “consisting of” is understood in the context of this application to exclude the presence of any unspecified element, ingredient or method step. As used herein, “consisting essentially of” is understood in the context of this application to include the specified elements, materials, ingredients or method steps “and those that do not materially affect the basic and novel characteristic(s)” of what is being described.

In this application, the use of the singular includes the plural and plural encompasses singular, unless specifically stated otherwise. For example, although reference is made herein to “an” ionic salt group-containing film-forming polymer and “a” curing agent, a combination (i.e., a plurality) of these components may be used. In addition, in this application, the use of “or” means “and/or” unless specifically stated otherwise, even though “and/or” may be explicitly used in certain instances.

Whereas specific aspects of the disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

Illustrating the disclosure are the following examples, which, however, are not to be considered as limiting the disclosure to their details. Unless otherwise indicated, all parts and percentages in the following examples, as well as throughout the specification, are by weight.

### EXAMPLES

### Preparation of Resin Systems: Resin System I

Preparation of Crosslinker I: A blocked polyisocyanate crosslinker, suitable for use in electrodepositable coating resins, was prepared in the following manner. Components 2, 3a, and 3b listed in Table 1, below, were added to a flask set up for total reflux with stirring under nitrogen. The content of the flask was heated to a temperature of 35° C., and Component 1 was added dropwise so that the temperature increased due to the reaction exotherm and was maintained under 100° ° C. After the addition of Component 1 was complete, component 4 was added and a temperature of 100° ° C. was established in the reaction mixture. The reaction mixture was held at temperature until no residual isocyanate was detected by IR spectroscopy. Components 5a and 5b were then added and the reaction mixture was allowed to stir for 30 minutes and cooled to ambient temperature.

TABLE 1
Components for the preparation of Crosslinker I

| | | Parts-by- |
|---|---|---|
| | | weight |
| No. | Component | (grams) |
| 1 | Polymeric methylene diphenyl diisocyanate¹ | 670 |
| 2 | K Kat XK 620 (Zn amidine) | 1.38 |
| 3a | Triethylene glycol monomethyl ether² | 574.7 |
| 3b | Kollisolv PEG 400³ | 300 |
| 4 | Butyl carbitol formal | 6 |
| 5a | Bisphenol A—ethylene oxide adduct | 66 |
| | (1/6 molar ratio BPA/EtO) | |
| 5b | Propylene glycol methyl ether | 80.9 |

¹Lupranate M20, available from BASF Corporation
²Available from Aldrich
³Available from BASF Corporation

Preparation of a Cationic, Amine-Functionalized, Polyepoxide-Based Resin (Resin System I): A cationic, amine-functionalized, polyepoxide-based polymeric resin, suitable for use in formulating electrodepositable coating compositions, was prepared in the following manner. Components 1˜4 listed in Table 2, below, were combined in a flask set up for total reflux with stirring under nitrogen. The mixture was heated to a temperature of 130° C. and allowed to exotherm (175° C. maximum). A temperature of 145° C. was established in the reaction mixture and the reaction mixture was then held for 1 hour. Component 5 was then introduced into the flask, followed by Components 6-7, and a temperature of 100° C. was established in the reaction mixture. Premixed components 8 and 9 were then added to the reaction mixture quickly and the reaction mixture was allowed to exotherm. A temperature of 110° C. was established in and the reaction mixture was held for 1 hour. Component 10 was then added and allowed to mix for 15 minutes. After the hold, the content of the flask was poured out and cooled to room temperature.

TABLE 2
Components for the preparation of Resin System I

| | | |
|---|---|---|
| | | Parts-by- |
| No. | Component | weight (grams) |

Resin Synthesis Stage

| | | |
|---|---|---|
| 1 | Bisphenol A diglycidyl ether¹ | 614.68 |
| 2 | Bisphenol A | 265.22 |
| 3 | Bisphenol A—ethylene oxide adduct | 100 |
| | (1/6 molar ratio BPA/EtO) | |
| 4 | Ethyl triphenyl phosphonium bromide | 0.6 |
| 5 | Bisphenol A—ethylene oxide adduct | 145.4 |
| | (1/6 molar ratio BPA/EtO) | |
| 6 | Crosslinker I² | 1093.25 |
| 7 | Butyl carbitol formal | 112 |
| 8 | N-(3-Aminopropyl)diethanolamine³ | 21.77 |
| 9 | Methyl ethanol amine | 47.1 |
| 10 | Propylene glycol methyl ether | 295.23 |

¹EPON 828, available from Hexion Corporation.
²See synthesis of Crosslinker I, above.
³Available from Huntsman or Air Products

### Preparation of Resin Systems: Resin System: Resin System II

Preparation of Crosslinker II: A blocked polyisocyanate crosslinker, suitable for use in electrodepositable coating resins, was prepared in the following manner. Components 1a, 1b, 1c, 1d, and 1e listed in Table 3, below, were added to a flask set up for total reflux with stirring under nitrogen. The content of the flask was heated to a temperature of 35° C., and Component 2 was added dropwise so that the temperature increased due to the reaction exotherm and was maintained under 110° C. After the addition of Component 2 was complete, component 3 was added and a temperature of 110° C. was established in the reaction mixture. The reaction mixture was held at temperature until no residual isocyanate was detected by IR spectroscopy. Component 4 was then added, and the reaction mixture was allowed to stir for 30 minutes and cooled to ambient temperature.

TABLE 3
Components for the preparation of Crosslinker II

| | | Parts-by- |
|---|---|---|
| No. | Component | weight (grams) |
| 1a | Propylene glycol | 76 |
| 1b | Butyl CELLOSOLVE | 826 |
| 1c | Bisphenol A—ethylene oxide adduct | 490 |
| | (1/6 molar ratio BPA/EtO) | |
| 1d | Dibutyltin dilaurate | 1.4 |
| 1e | Butyl carbitol formal | 12.6 |
| 2 | Polymeric methylene diphenyl diisocyanate ¹ | 1340 |
| 3 | Butyl carbitol formal | 12.6 |
| 4 | Propylene glycol methyl ether | 330.1 |

¹ Lupranate M20, available from BASF Corporation
² Available from Aldrich
³ Available from BASF Corporation

Preparation of a Cationic, Amine-Functionalized, Polyepoxide-Based Resin (Resin System II): A cationic, amine-functionalized, polyepoxide-based polymeric resin, suitable for use in formulating electrodepositable coating compositions, was prepared in the following manner. Components 1˜4 listed in Table 4, below, were combined in a flask set up for total reflux with stirring under nitrogen. The mixture was heated to a temperature of 130° ° C. and allowed to exotherm (175° C. maximum). A temperature of 145° ° C. was established in the reaction mixture and the reaction mixture was then held for 1 hour. Component 5 was then introduced into the flask, followed by Components 6-7, and a temperature of 100° C. was established in the reaction mixture. Premixed components 8 and 9 were then added to the reaction mixture quickly and the reaction mixture was allowed to exotherm. A temperature of 110° ° C. was established in and the reaction mixture was held for 1 hour. Component 10 was then added and allowed to mix for 15 minutes. After the hold, the content of the flask was poured out and cooled to room temperature.

TABLE 4
Components for the preparation of Resin System II

| | | |
|---|---|---|
| | | Parts-by- |
| No. | Component | weight (grams) |

Resin Synthesis Stage

| | | |
|---|---|---|
| 1 | Bisphenol A diglycidyl ether¹ | 469.5 |
| 2 | Bisphenol A | 202.7 |
| 3 | Bisphenol A—ethylene oxide adduct | 149.8 |
| | (1/6 molar ratio BPA/EtO) | |
| 4 | Ethyl triphenyl phosphonium bromide | 0.46 |
| 5 | Bisphenol A—ethylene oxide adduct | 141.8 |
| | (1/6 molar ratio BPA/EtO) | |
| 6 | Crosslinker II² | 797.7 |
| 7 | Butyl carbitol formal | 25.2 |
| 8 | N-(3-Aminopropyl)diethanolamine³ | 16.6 |
| 9 | Methyl ethanol amine | 35.9 |
| 10 | Propylene glycol methyl ether | 160.2 |

¹EPON 828, available from Hexion Corporation.
²See synthesis of Crosslinker II, above.
³Available from Huntsman or Air Products

### Preparation of Electrodepositable Coating Compositions

Sources of Formulation Pigments, Additives, and Chemicals: Chemicals used for formulation of electrocoat baths were obtained from various suppliers. The solvent DOWANOL PM was obtained from Dow Chemical Company at 98% purity. Sulfamic acid was obtained from PPG industries. TIONA 595 titanium dioxide pigment may be obtained from Tronox Inc. Barium sulfate pigment may be obtained from Venator Materials PLC. ASP-200 clay pigment may be obtained from BASF.

Control Composition 1: This electrocoat is commercially available from PPG Industries under the name FRAMECOAT II and is supplied as a two-component composition. The electrocoat bath was prepared by mixing 1801 grams of CR681 resin (available from PPG), CP524 paste (243.8 grams, available from PPG) and deionized water (1755.2 grams). The P:B of this paint was 0.1:1.0. Composition 1 was used according to the technical bulletin.

Composition 2: A stainless steel beaker (3-liter) was loaded with 593 grams of Resin System I which had been warmed to 80° C. using thermocouple and heating mantle. A 3-inch propeller blade was used to agitate the resin at 1500 RPM powered by a Fawcett air motor (Model 103A). The following ingredients were added in the order listed. To the resin was added, 57.5 grams of deionized water and allowed to mix for 5 minutes. Next, 300 grams of ASP-200 was added to the resin over five minutes. This mixture was agitated for twenty minutes. In a separate stainless-steel beaker (1-liter), 7.41 grams of sulfamic acid was added to 387.4 grams of deionized water and mixed for fifteen minutes under mild agitation. After an adequate dispersion was achieved with the resin mixture, the acid solution was slowly poured into the resin mixture while continuing agitation. The acidified resin mixture was held for one hour while continuing agitation. After the one-hour hold, the resin mixture was thinned down with 448.6 grams of deionized water over 20 minutes, allowing the temperature to fluctuate naturally. Tin-catalyst was then added by adding 21.2 grams of E6165 (a dibutyl tin oxide [DBTO] paste available from PPG Industries) to provide a Sn loading of 0.7 weight % on resin solids. Finally, an additional 1435.4 grams of deionized water was added to make a finished electrocoat bath at 25 wt. % solids. The final bath pH was 5.89 and the conductivity was 960 μS.

Composition 3: A stainless steel beaker (3-liter) was loaded with 593 grams of Resin System I which had been warmed to 80° C. using thermocouple and heating mantle. A 3-inch propeller blade was used to agitate the resin at 1500 RPM powered by a Fawcett air motor (Model 103A). The following ingredients were added in the order listed. To the resin was added, 57.5 grams of deionized water and allowed to mix for 5 minutes. Next, 95 grams of ASP-200 was added to the resin over five minutes, followed by 55 grams of barium sulfate pigment, followed by 150 grams of TIONA 595 titanium dioxide pigment. This mixture was agitated for twenty minutes. In a separate stainless-steel beaker (1-liter), 7.41 grams of sulfamic acid was added to 387.4 grams of deionized water and mixed for fifteen minutes under mild agitation. After an adequate dispersion was achieved with the resin mixture, the acid solution was slowly poured into the resin mixture while continuing agitation. The acidified resin mixture was held for one hour while continuing agitation. After the one-hour hold, the resin mixture was thinned down with 448.6 grams of deionized water over 20 minutes, allowing the temperature to fluctuate naturally. Tin-catalyst was then added by adding 21.2 grams of E6165 (a dibutyl tin oxide [DBTO] paste available from PPG Industries) to provide a Sn loading of 0.7 weight % on resin solids. Finally, an additional 1435.4 grams of deionized water was added to make a finished electrocoat bath at 25 wt. % solids. The final bath pH was 5.78 and the conductivity was 974 μS.

Composition 4: A stainless steel beaker (4-liter) was loaded with 807.9 grams of Resin System II which had been warmed to 80° C. using thermocouple and heating mantle. A 3-inch propeller blade was used to agitate the resin at 1500 RPM powered by a Fawcett air motor (Model 103A). The following ingredients were added in the order listed. To the resin was added, 80.5 grams of deionized water and allowed to mix for 5 minutes. Next, 420 grams of ASP-200 was added to the resin over five minutes. This mixture was agitated for twenty minutes. In a separate stainless-steel beaker (1-liter), 10.57 grams of sulfamic acid was added to 736.7 grams of deionized water and mixed for fifteen minutes under mild agitation. After an adequate dispersion was achieved with the resin mixture, the acid solution was slowly poured into the resin mixture while continuing agitation. The acidified resin mixture was held for one hour while continuing agitation. After the one-hour hold, the resin mixture was thinned down with 456.8 grams of deionized water over 20 minutes, allowing the temperature to fluctuate naturally. Tin-catalyst was then added by adding 29.6 grams of E6165 (a dibutyl tin oxide [DBTO] paste available from PPG Industries) to provide a Sn loading of 0.7 weight % on resin solids. Finally, an additional 2009.9 grams of deionized water was added to make a finished electrocoat bath at 25 wt. % solids. The final bath pH was 5.72 and the conductivity was 1085 μS.

Composition 5: A rheology additive solution was prepared by adding deionized water (945 grams), BORCHI Gel 0620 (150 grams), commercially available from Borchers Americas Inc, and ethylene glycol butyl ether (405 grams) to a steel beaker (3-liter) and agitated for 1 hour with a high lift impellor blade at 500 RPM powered by a Fawcett air motor (Model 103A).

In a separate stainless-steel beaker (4-liter) was loaded with 807.9 grams of Resin System II which had been warmed to 80° C. using thermocouple and heating mantle. A 3-inch propeller blade was used to agitate the resin at 1500 RPM powered by a Fawcett air motor (Model 103A). The following ingredients were added in the order listed. To the resin was added, 80.5 grams of deionized water and allowed to mix for 5 minutes. Next, 420 grams of ASP-200 was added to the resin over five minutes. This mixture was agitated for twenty minutes. In a separate stainless-steel beaker (1-liter), 10.57 grams of sulfamic acid was added to 577.8 grams of deionized water and mixed for fifteen minutes under mild agitation. After an adequate dispersion was achieved with the resin mixture, the acid solution was slowly poured into the resin mixture while continuing agitation. The acidified resin mixture was held for one hour while continuing agitation. After the one-hour hold, the resin mixture was thinned down with 175 grams of the rheology additive solution and 461.3 grams of deionized water over 20 minutes, allowing the temperature to fluctuate naturally. Tin-catalyst was then added by adding 29.8 grams of E6165 (a dibutyl tin oxide [DBTO] paste available from PPG Industries) to provide a Sn loading of 0.7 weight % on resin solids. Finally, an additional 2029.8 grams of deionized water was added to make a finished electrocoat bath at 25 wt. % solids. The final bath pH was 5.85 and the conductivity was 1101 μS.

Composition 6: A stainless steel beaker (3-liter) was loaded with 534 grams of Resin System I which had been warmed to 80° C. using thermocouple and heating mantle. A 3-inch propeller blade was used to agitate the resin at 1500 RPM powered by a Fawcett air motor (Model 103A). The following ingredients were added in the order listed. To the resin was added, 51.8 grams of deionized water and allowed to mix for 5 minutes. Next, 382.5 grams of ASP-200 was added to the resin over five minutes. This mixture was agitated for twenty minutes. In a separate stainless-steel beaker (1-liter), 6.67 grams of sulfamic acid was added to 423.7 grams of deionized water and mixed for fifteen minutes under mild agitation. After an adequate dispersion was achieved with the resin mixture, the acid solution was slowly poured into the resin mixture while continuing agitation. The acidified resin mixture was held for one hour while continuing agitation. After the one-hour hold, the resin mixture was thinned down with 466.2 grams of deionized water over 20 minutes, allowing the temperature to fluctuate naturally. Tin-catalyst was then added by adding 19 grams of E6165 (a dibutyl tin oxide [DBTO] paste available from PPG Industries) to provide a Sn loading of 0.7 weight % on resin solids. Finally, an additional 932.4 grams of deionized water was added to make a finished electrocoat bath at 30 wt. % solids. The final bath pH was 5.7 and the conductivity was 928 μS.

### Test Methods

Settling quantity test method: The amount of settle over a set amount of time was determined using a Biolin Scientific Attension Force Tensiometer (Model: Sigma 703) equipped with a platinum pan. A small sample of electrodepositable coating composition was placed into 4 oz. glass jar. The glass jar containing the electrodepositable coating composition was loaded onto the tensiometer platform and the platinum pan was inserted into the paint below the liquid surface. The instrument was zeroed, and data collection began. The amount of settling of the components of the composition (reported in mg) was monitored over a thirty-minute period.

The settling was also evaluated relative to the P:B of the electrodepositable coating composition. This was determined by dividing the total amount of settled components of the composition by the P:B of the composition. This is referred to herein as the “RELATIVE SEDIMENTATION TEST METHOD.”

Bath viscosity test method: Flow curves of the liquid baths were determined by measuring viscosity as a function of shear rate. Viscosity was measured with an Anton-Paar MCR302 rheometer using a concentric cylinder (cup and bob) setup with temperature-control. The temperature was a constant 32° C. The viscosity of the electrocoat baths were first measured at a constant shear rate of 0.1 s⁻¹ for 21 data points with duration set by device, to stabilize the coating system to a steady state. Then, the viscosity was measured at a logarithmic ramp of shear rate from 0.1 to 1000 s⁻¹, varying the shear rate at a point spacing of 5 points per decade with duration set by device. The low-shear viscosity is at a shear rate of 0.1 s⁻¹ and the high-shear viscosity is reported at a shear rate of 100 s⁻¹. This test method is referred to herein as the BATH VISCOSITY TEST METHOD.

L-Panel surface roughness test method: Metal substrate panels (optionally pretreated with a pretreatment composition (e.g., a zinc phosphate pretreatment composition)) and cut into half to yield a 4″ by 6″ panel. Then, 0.25 inches was removed from each side of the panel resulting in a panel that was 3.5″ by 6″, which was bent into an “L” shape yielding a 4-in vertical surface and 2-inch horizontal surface. This panel was submerged into the electrocoat bath that is under agitation, and the agitation may be stopped. After three minutes of sitting in the unagitated bath, electrodeposition of the composition proceeded. A rectifier was used to apply the electrical current to the electrodepositable coating bath to coat the substrate. The target film build was from 0.5 to 0.7 mils (12.7 to 17.8 microns) on the vertical face of the substrate. This film thickness was deposited by using the voltage/temperature/current conditions for a DFT of 25.4 microns (two-minute condition), but for one minute. The exact coating conditions may vary by composition. After the panels are electrocoated, the panels are rinsed with deionized water and baked at 350° F. for 30 minutes in an electric oven. The roughness of the horizontal and vertical surfaces was measured using a Precision Surtronic 25 Profilometer available from Taylor Hobson. The instrument was referenced using 3-inch silicon wafer available from Ted Pella Inc. (Product Number 16013), which had a roughness of 1.0±0.7 microinches after 10 repeat measurements. This test method is referred to herein as the L-PANEL SURFACE ROUGHNESS TEST METHOD.

Complex viscosity test method: Viscosity of a deposited coating during a cure cycle was measured with the following method. Step (a) setting up an Anton Paar MCR 302 Rheometer with a PPR 25/23 spindle and 0.1 mm gap; (b) applying tetrahydrofuran (THF) to the uncured electrodeposited coating sample and using a metal spatula to scrape uncured electrodeposited coating sample off of a panel and placing the sample on the Peltier plate; (c) measuring viscosity of the sample over time with the sample under constant shear strain (oscillating) at 5% and frequency at 1 Hz held throughout the length of the test, and a cure cycle of 30 minute ambient flash at 40° ° C. followed by a temperature ramp from 40° ° C. to 175° C. over 41 minutes (3.3° C./min). This test method is referred to herein as the COMPLEX VISCOSITY TEST METHOD.

### Example A: Evaluation of Bath Stability

CRS panels pretreated with zinc phosphate (C700 item: 28630 available from ACT, Hillsdale, MI.) were prepared in the manner described in the L-PANEL SURFACE ROUGHNESS TEST METHOD. A rectifier (Xantrax Model XFR600-2, Elkhart, Indiana, or Sorensen XG 300-5.6, Ameteck, Berwyn, Pennsylvania) which was DC-power supplied was used to apply the electrodepositable coating. This film thickness was deposited by using a voltage/temperature/current condition for two minutes. Exact coating conditions for each paint are found in the Table 5. After panels were electrocoated, these panels were rinsed with deionized water and baked at 350° F. for 30 minutes in an electric oven (Despatch Model LFD-1-42). After baking, the panels were allowed to cool at ambient conditions for 20 minutes. Results from the L-PANEL SURFACE ROUGHNESS TEST METHOD and the BATH VISCOSITY TEST METHOD conducted on the corresponding electrodepositable coating bath are in table 6 below.

TABLE 5
Coat out conditions for L Panel Surface Roughness Test Method

| | Bath | Coat Out | Coat out |
|---|---|---|---|
| | Temperature | Voltage | Current Limit |
| Composition | (° F.) | (V) | (A) |
| Control Comp. 1 | 90 | 225 | 0.5 |
| Comp. 2 | 90 | 285 | 0.5 |
| Comp. 3 | 90 | 285 | 0.5 |
| Comp. 4 | 90 | 285 | 0.5 |
| Comp. 5 | 90 | 285 | 0.5 |

TABLE 6
Comparison of L Panel Surface Roughness, Settling Quantity, and Bath Viscosity

| | | | | | | Hor. | | |
|---|---|---|---|---|---|---|---|---|
| | | | | | | Surface | | |
| | | | | Low- | High- | Rough. | Settle | |
| | Cross- | Pigment | Bath | Shear | Shear | (micro- | Quantity | Settle |
| Ex. | linker | Comp. | Modifier | Visc. | Visc. | inches) | (mg) | mg/P:B |
| Control | Com. | 0.1 P:B | none | 10.88 | 2 | 21 | 9.2 | 92 |
| Comp. | | Clay and | | | | | | |
| 1 | | Carbon | | | | | | |
| | | black | | | | | | |
| Comp. | I | 0.6 P:B | none | 62.3 | 4 | 23.27 | 7.2 | 12 |
| 2 | | ASP-200 | | | | | | |
| Comp. | I | 0.19 P:B | none | 15.7 | 4.3 | 24.57 | 23.8 | 39.7 |
| 3 | | ASP-200, | | | | | | |
| | | 0.11 P:B | | | | | | |
| | | BaSO4, | | | | | | |
| | | 0.3 P:B | | | | | | |
| | | TiO2 | | | | | | |
| Comp. | II | 0.6 P:B | none | 14.4 | 2.1 | 93.81 | 76.9 | 128.2 |
| 4 | | ASP-200 | | | | | | |
| Comp. | II | 0.6 P:B | Rheology | 17.3 | 3.3 | 81.6 | 45.1 | 75.2 |
| 5 | | ASP-200 | modifier | | | | | |

The results in table 6 indicate that the rheological properties of the electrodepositable coating compositions can be used to stabilize the compositions against sedimentation. For example, compositions 2, 3, and 5 each have a P:B of 0.6:1 and have a low-shear viscosity of at least 15 and demonstrate good relatively low settling quantity, a low settling quantity relative to the total P:B ratio of the composition, and good horizontal surface roughness of the resulting applied coating. This is particularly true to compositions 2 and 3 that included a polyisocyanate curing agent that includes a polyether blocking agent. In contrast, composition 4 did not have sufficient low-shear viscosity in order to prevent a high amount of settling and resulted in a rough horizontal surface. However, the addition of a thickener to composition 4 as shown in composition 5 resulted in an increased low-shear viscosity, significantly reduced settling and settling per P:B, and a less rough horizontal surface.

The results in table 6 also show a comparison to a commercially available composition, control composition 1, having a lower P:B of 0.1:1. Although control composition 1 did not have a very high low-shear viscosity, the composition was still stable and did not result in a high horizontal surface roughness because of the relatively low pigment content. In contrast, compositions 2 and 3 provide slightly rougher but comparable horizontal surface roughness despite having a six times higher pigment content that would be expected to have more settling. Likewise, composition have had less settling relative to the composition P:B than control composition 1.

### Example B: Cure Viscosity and Appearance

To measure the minimum complex viscosity as described in the COMPLEX VISCOSITY TEST METHOD, electrodeposited films were applied over bare, uncleaned, 3003 H14 Aluminum substrate provided by Q-Lab Corporation. Coatings were applied with a 1-amp current limit at 285 volts for 120 seconds at a bath temperature of 90° F. The uncured deposited coatings were then handled as described in the COMPLEX VISCOSITY TEST METHOD.

To measure cured film appearance, CRS panels pretreated with zinc phosphate (C700 item: 28630 available from ACT, Hillsdale, MI.) were prepared by cutting the panels in half to yield a 4″ by 6″ panel. The electrodepositable compositions were then applied with a 1-amp current limit at 285 volts for 120 seconds at a bath temperature of 90° F. After the panels were electrocoated, the panels were rinsed with deionized water and baked at 350° F. for 30 minutes in an electric oven. After baking, the panels were allowed to cool for 30 minutes. The roughness of the cured coated surfaces was then measured using a Precision Surtronic 25 Profilometer available from Taylor Hobson.

The results of the complex viscosity test method and cured film appearances can be found in Table 7.

TABLE 7
Complex viscosity

| | | | Minimum | Cured Coating |
|---|---|---|---|---|
| | Cross- | | complex | Appearance |
| Composition | linker | Pigment | viscosity (cP) | (microinches) |
| Comp. 2 | I | 0.6 P:B | 7207 | 12.5 |
| | | ASP-200 | | |
| Comp. 6 | I | 0.85 P:B | 11745 | 35.4 |
| | | ASP-200 | | |

The results in Table 7 indicate that increasing pigmentation can lead to an increased viscosity profile during the curing process, which has an impact on final cured coating appearance. A reduced minimum complex viscosity may result in lower cured coating appearance roughness.

It will be appreciated by skilled artisans that numerous modifications and variations are possible in light of the above disclosure without departing from the broad inventive concepts described and exemplified herein. Accordingly, it is therefore to be understood that the foregoing disclosure is merely illustrative of various exemplary aspects of this application and that numerous modifications and variations can be readily made by skilled artisans which are within the spirit and scope of this application and the accompanying claims.

1. An electrodepositable coating composition comprising:
an electrodepositable binder comprising an ionic salt group-containing film-forming polymer and a curing agent; and
at least one pigment;
wherein the electrodepositable coating composition has a resin solids content of less than 30% by weight, based on the total weight of the electrodepositable coating composition, and a viscosity of at least 15 cP at a shear rate of 0.1/s as measured by the BATH VISCOSITY TEST METHOD; and
wherein the pigment optionally comprises a phyllosilicate pigment, and the pigment-to-binder ratio of the phyllosilicate pigment to the electrodepositable binder is less than 0.2:1 if the electrodepositable coating composition is a cationic electrodepositable coating composition and a pigment dispersing acid is present in the cationic electrodepositable coating composition.

2. The electrodepositable coating composition of claim 1, wherein the electrodepositable coating composition has a resin solids content of less than 30% by weight, based on the total solids of the electrodepositable coating composition, and a viscosity of less than 15 cP at a shear rate of 100/s as measured by the BATH VISCOSITY TEST METHOD.

3. The electrodepositable coating composition of claim 1, wherein the electrodepositable coating composition has pigment-to-binder ratio of at least 0.3:1 and a coating electrodeposited from the electrodepositable coating composition has a minimum complex viscosity during cure of no more than 5,000 to 300,000 cP, as measured by the COMPLEX VISCOSITY TEST METHOD.

4. The electrodepositable coating composition of claim 1, wherein the composition has a VOC of less than 1.5 lb/gallon.

5. The electrodepositable coating composition of claim 1, wherein the electrodepositable coating composition has a pigment-to-binder (P:B) ratio of 0.3:1 to 2.0:1.

6. The electrodepositable coating composition of claim 1, wherein a coating deposited from the electrodepositable coating composition has a horizontal surface roughness of less than 90 microinches, as measured by the L-PANEL SURFACE ROUGHNESS TEST METHOD.

7. The electrodepositable coating composition of claim 1, wherein a coating deposited from the electrodepositable coating composition has a vertical surface roughness of less than 75 microinches, as measured by the L-PANEL SURFACE ROUGHNESS TEST METHOD.

8. The electrodepositable coating composition of claim 1, further comprising a pigment dispersing acid.

9. The electrodepositable coating composition of claim 1, wherein the pigment comprises an iron oxide, a lead oxide, strontium chromate, carbon black, coal dust, titanium dioxide, barium sulfate, a color pigment, a phyllosilicate pigment, a metal pigment, a thermally conductive, electrically insulative filler, a fire-retardant pigment, or any combination thereof.

10. The electrodepositable coating composition of claim 1, wherein the electrodepositable coating composition is an anionic electrodepositable coating composition.

11. The electrodepositable coating composition of claim 1, wherein the electrodepositable coating composition is a cationic electrodepositable coating composition.

12. The electrodepositable coating composition of claim 11, wherein the cationic electrodepositable coating composition is substantially free of a pigment dispersing acid or a silane dispersant.

13. The electrodepositable coating composition of claim 11, wherein the cationic electrodepositable coating composition is substantially free of phyllosilicate pigment if the cationic electrodepositable coating composition comprises a pigment dispersing acid.

14. The electrodepositable coating composition of claim 1, wherein the electrodepositable coating composition is substantially free of metal pigment and/or electrically conductive pigment.

15. The electrodepositable coating composition of claim 1, wherein the curing agent comprises an at least partially blocked polyisocyanate, an aminoplast resin, a phenoplast resin, or a combination thereof.

16-19. (canceled)

20. The electrodepositable coating composition of claim 1, further comprising a rheology modifier.

21. (canceled)

22. The electrodepositable coating composition of claim 1, wherein the electrodepositable coating composition has a relative sedimentation of no more than 90 mg/P:B, as measured by the RELATIVE SEDIMENTATION TEST METHOD.

23. A method for coating a substrate comprising electrodepositing a coating derived from the electrodepositable coating composition of claim 1 onto at least a portion of the substrate.

24. (canceled)

25. A substrate that is coated, at least in part, with a coating deposited from the electrodepositable coating composition of claim 1.

26-28. (canceled)

29. A substrate comprising an electrodeposited coating layer comprising an electrodepositable binder and a pigment, wherein the electrodeposited coating layer has a pigment-to-binder ratio of at least 0.3:1 and the electrodeposited coating layer has a horizontal surface roughness of less than 90 microinches, as measured by the L-PANEL SURFACE ROUGHNESS TEST METHOD.
